(19) United States
(12) Patent Application Publication
(10) Pub. No.: US 2017/0011466 A1
(43) Pub. Date: Jan. 12, 2017

(54) SYSTEMS AND METHODS FOR MODULAR DATA PROCESSING

(71) Applicant: The Travelers Indemnity Company, Hartford, CT (US)

(72) Inventors: Syam Murikipudi, Elkridge, MD (US); Rose Weiner Spofford, Chester Springs, PA (US); Christine Steben, Avon, CT (US)

(21) Appl. No.: 14/797,055

(22) Filed: Jul. 10, 2015

(51) Int. Cl. G06Q 40/08

(52) U.S. Cl. CPC G06Q 40/08

(57) ABSTRACT

Systems, methods, and articles of manufacture provide for modular data processing which accepts specific data inputs into complex and specially-programmed data processing modules configured to be executed in a synchronous, multi-threaded, and/or parallel processing system environment.

### BACKGROUND

Expansion of business that leverages large amounts of data nationally and internationally has created a data processing environment that permits many complex decisions and data management operations to be implemented in connection with business operations. In the case that such decisions or operations are dependent upon geographic rules or regulations, however, complex programming must typically be employed to include exceptions or special geographic or jurisdictional rules into such decision making processes and data management operations. This complexity increases information technology implementation and maintenance costs and decreases the flexibility available for implementing changes across various jurisdictions.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a flow diagram of a method according to some embodiments;

FIG. 3 is a flow diagram of a method according to some embodiments;

FIG. 4 is a flow diagram of a method according to some embodiments;

FIG. 5 is a flow diagram of a method according to some embodiments;

FIG. 6 is a flow diagram of a method according to some embodiments;

FIG. 7 is a diagram of an example data storage structure according to some embodiments;

FIG. 8 is a block diagram of an apparatus according to some embodiments; and

FIG. 9A, FIG. 9B, FIG. 9C, FIG. 9D, and FIG. 9E are perspective diagrams of exemplary data storage devices according to some embodiments.

### DETAILED DESCRIPTION

### I. Introduction

Embodiments presented herein are descriptive of systems, apparatus, methods, and articles of manufacture for providing modular data processing. Typical processing solutions to address jurisdictional variations in rules or required data processing operations, for example, require duplicative coding efforts such as by establishing multiple software-based models that are selectively invoked depending upon some jurisdictional data processing trigger. Multiple versions of a particular model, each having built-in variations for particular jurisdictions, for example, may be available simultaneously and separately in a run-time environment of a large, multi-jurisdictional data processing operation.

Initial coding and implementation of such multiple models, as well as ongoing duplicative maintenance efforts, however, tax both human labor resources, as well as memory storage device capacity. Such a typical multi-jurisdictional and multi-model implementation is also inflexible and requires much effort to update, such as by updating a model for a particular jurisdiction or adding a new version of the model to accommodate a new jurisdiction.

In accordance with embodiments herein, these and other deficiencies of previous efforts are remedied, such as by providing a modular data processing system, as described herein. In some embodiments for example, a single data processing model may be maintained and driven by data stored in a “steering” table, which allows for modular activation of different versions of model segments or modules. This, and other features of embodiments described herein, may provide for decreased model setup costs, quicker implementation, less maintenance, and a higher level of flexibility and ease of variation than previous techniques.

### II. Modular Data Processing Systems and Methods

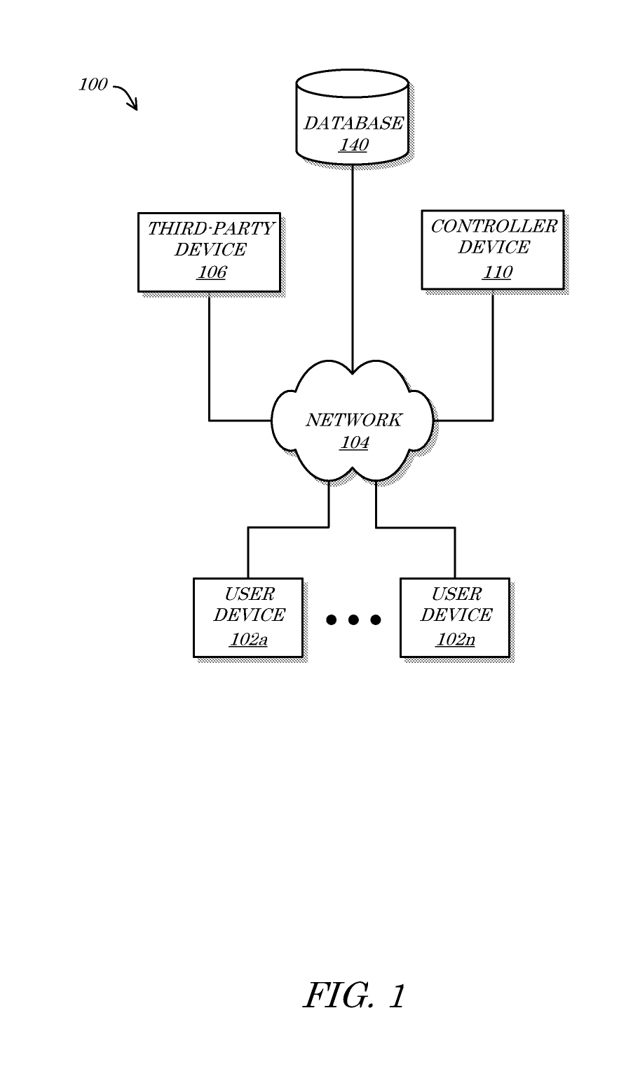

Referring first to FIG. 1, a block diagram of a system 100 according to some embodiments is shown. In some embodiments, the system 100 may comprise a plurality of user devices 102a-n, a network 104, a third-party device 106, a controller device 110, and/or a database 140. As depicted in FIG. 1, any or all of the devices 102a-n, 106, 110, 140 (or any combinations thereof) may be in communication via the network 104. In some embodiments, the system 100 may be utilized to receive entity data (such as, but not limited to, entity address, entity geographic coordinates, and/or entity characteristic data, e.g., for a business entity, gross sales, employment data, loss data, etc.), and/or other data or metrics. The controller device 110 may, for example, interface with one or more of the user devices 102a-n and/or the third-party device 106 to receive entity data and process such data in accordance with one or more data processing algorithms or models. In the case of risk and/or insurance analysis, for example, entity data may be analyzed in accordance with a modular data processing model that permits multiple data processing paths, e.g., based on different geographic groupings.

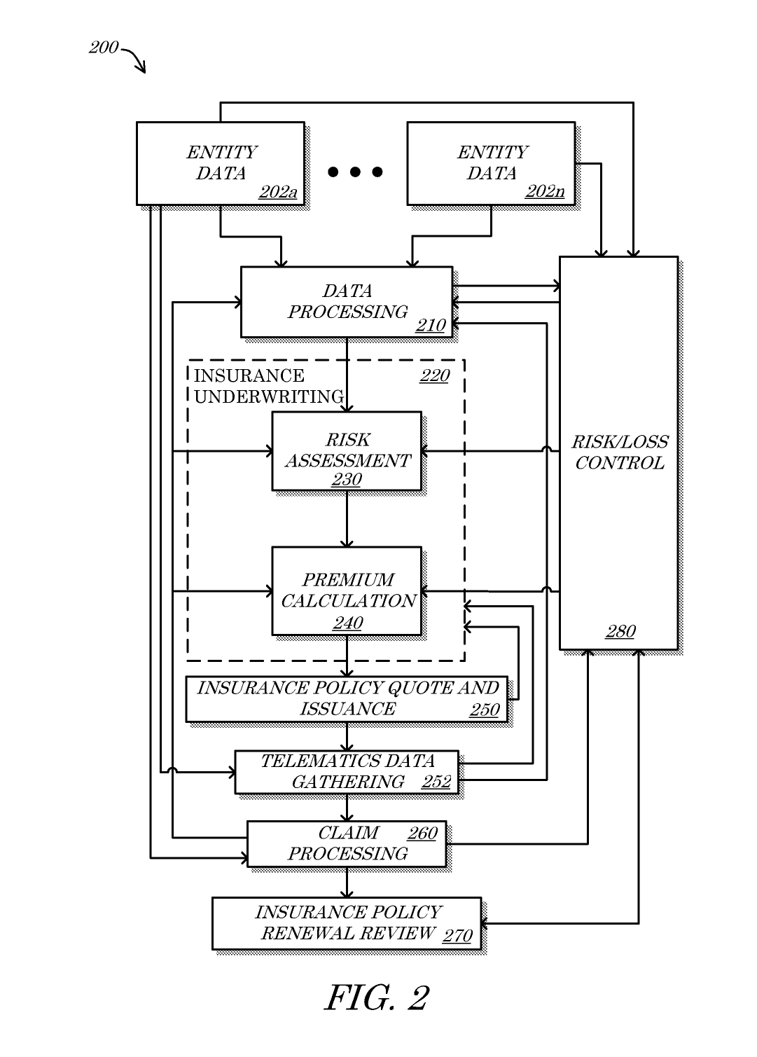

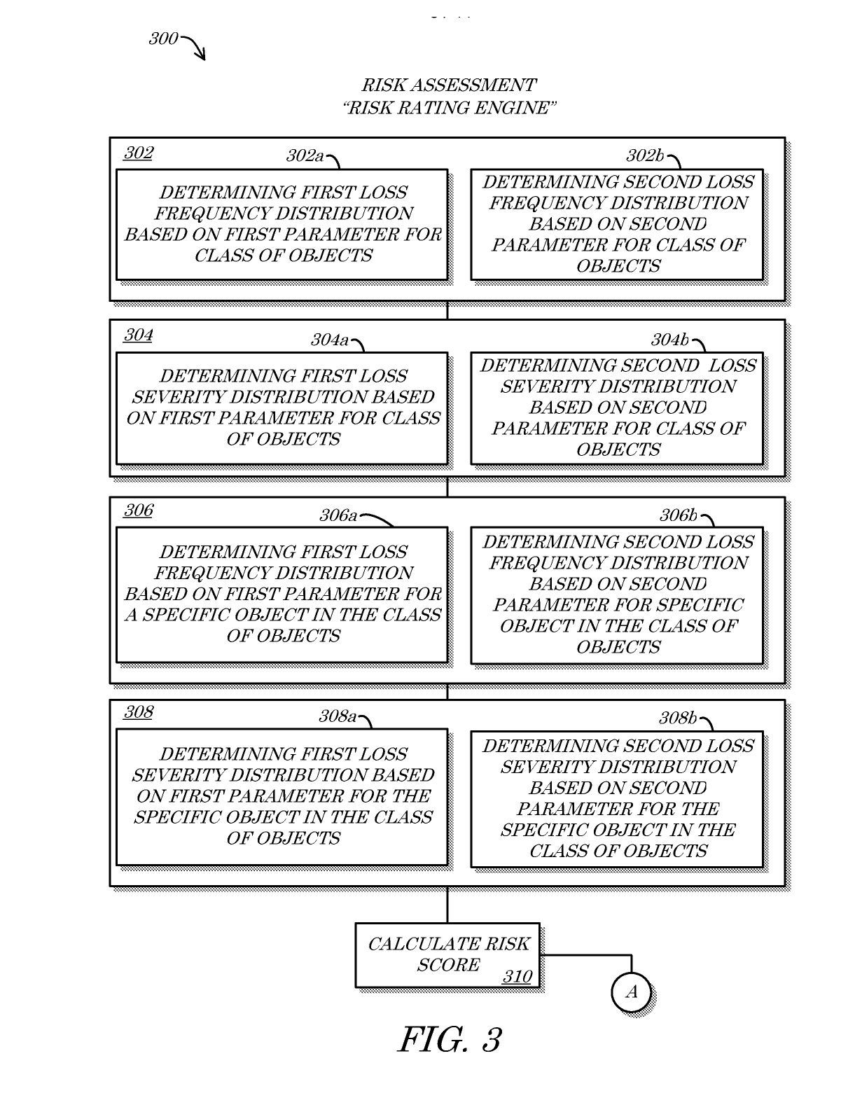

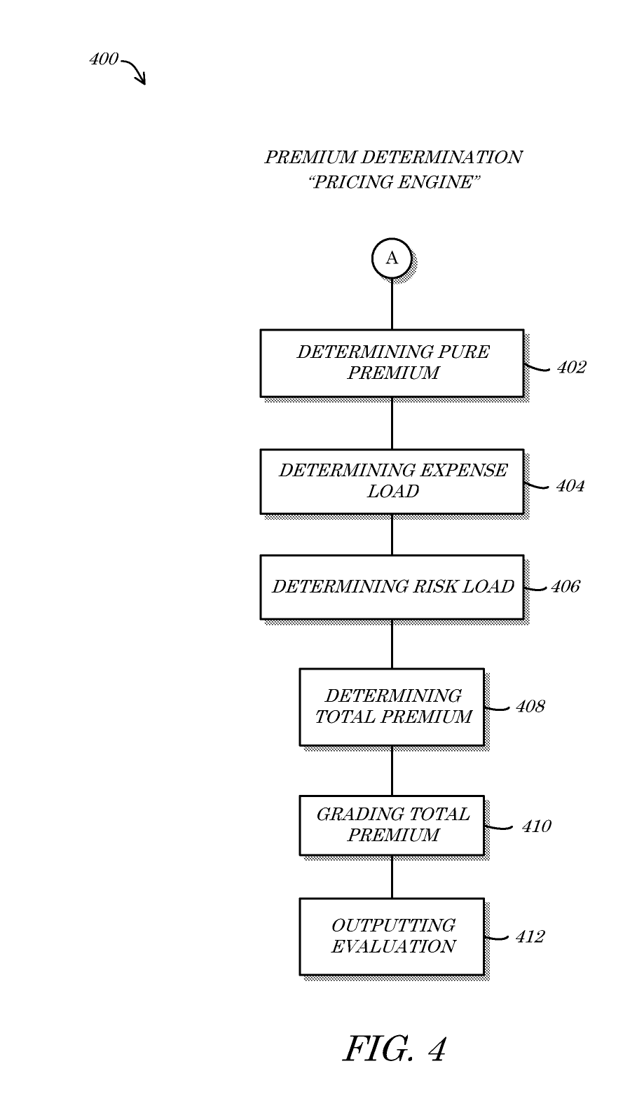

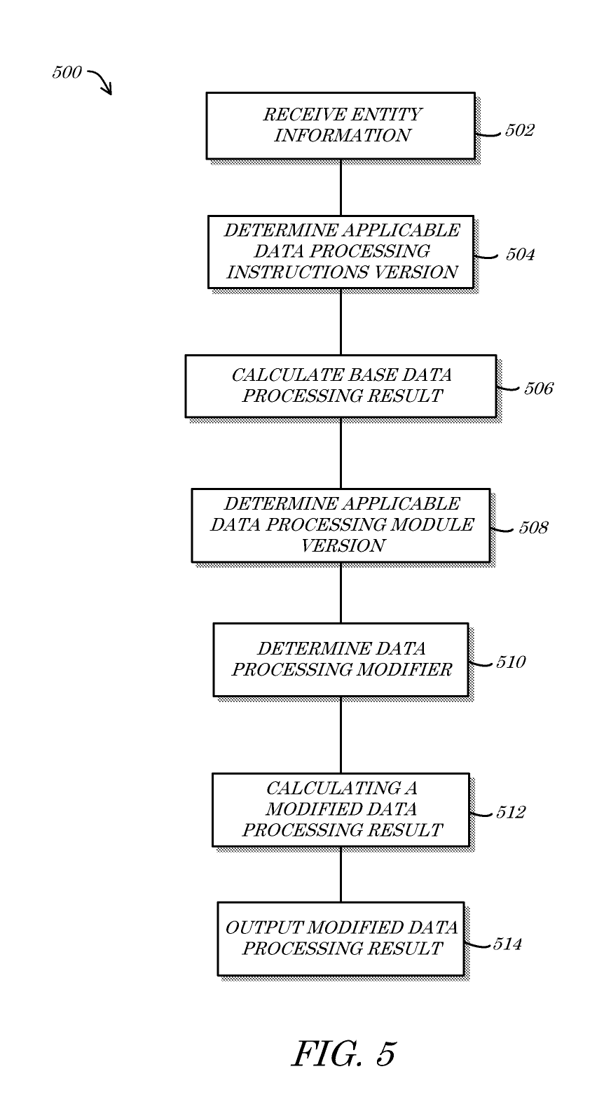

Fewer or more components 102a-n, 104, 106, 110, 140 and/or various configurations of the depicted components 102a-n, 104, 106, 110, 140 may be included in the system 100 without deviating from the scope of embodiments described herein. In some embodiments, the components 102a-n, 104, 106, 110, 140 may be similar in configuration and/or functionality to similarly named and/or numbered components as described herein. In some embodiments, the system 100 (and/or portion thereof) may comprise a risk assessment and/or underwriting or sales program, system, and/or platform programmed and/or otherwise configured to execute, conduct, and/or facilitate any of the various methods 200, 300, 400, 500, 600 of FIG. 2, FIG. 3, FIG. 4, FIG. 5, and/or FIG. 96 herein, and/or portions or combinations thereof.

The user devices 102a-n, in some embodiments, may comprise any types or configurations of computing, mobile electronic, network, user, and/or communication devices that are or become known or practicable. The user devices 102a-n may, for example, comprise one or more Personal Computer (PC) devices, computer workstations (e.g., an underwriter workstation), tablet computers such as an iPad® manufactured by Apple®, Inc. of Cupertino, Calif., and/or cellular and/or wireless telephones such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user devices 102a-n may comprise devices owned and/or operated by one or more users such as claim handlers, field agents, underwriters, account managers, agents/brokers, customer service representatives, data acquisition partners and/or consultants or service providers, and/or underwriting product customers (or potential customers, e.g., consumers). According to some embodiments, the user devices 102a-n may communicate with the controller device 110 via the network 104, such as to conduct underwriting inquiries and/or processes utilizing modular data processing model process flow routing and/or versioning as described herein.

In some embodiments, the user devices 102a-n may interface with the controller device 110 to effectuate communications (direct or indirect) with one or more other user devices 102a-n (such communication not explicitly shown in FIG. 1), such as may be operated by other users. In some embodiments, the user devices 102a-n may interface with the controller device 110 to effectuate communications (direct or indirect) with the third-party device 106 (such communication also not explicitly shown in FIG. 1). In some embodiments, the user devices 102a-n and/or the third-party device 106 may comprise one or more sensors configured and/or couple to sense, measure, calculate, and/or otherwise process or determine policy, geo-spatial, business classification, weather and/or other risk data, and/or claim data. In some embodiments, such sensor data may be provided to the controller device 110, such as to influence process routing and/or versioning, conduct claim handling, pricing, risk assessment, line and/or limit setting, quoting, and/or selling or re-selling of an underwriting product (e.g., utilizing selective and/or modular data processing process flow routing and/or versioning as described herein).

The network 104 may, according to some embodiments, comprise a Local Area Network (LAN; wireless and/or wired), cellular telephone, Bluetooth®, Near Field Communication (NFC), and/or Radio Frequency (RF) network with communication links between the controller device 110, the user devices 102a-n, the third-party device 106, and/or the database 140. In some embodiments, the network 104 may comprise direct communications links between any or all of the components 102a-n, 106, 110, 140 of the system 100. The user devices 102a-n may, for example, be directly interfaced or connected to one or more of the controller device 110 and/or the third-party device 106 via one or more wires, cables, wireless links, and/or other network components, such network components (e.g., communication links) comprising portions of the network 104. In some embodiments, the network 104 may comprise one or many other links or network components other than those depicted in FIG. 1. The user devices 102a-n may, for example, be connected to the controller device 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140 of the system 100. The network 104 may comprise one or more cellular telephone networks with communication links between the user devices 102a-n and the controller device 110, for example, and/or may comprise the Internet, with communication links between the controller device 110 and the third-party device 106 and/or the database 140, for example.

The third-party device 106, in some embodiments, may comprise any type or configuration of a computerized processing device such as a PC, laptop computer, computer server, database system, and/or other electronic device, devices, or any combination thereof. In some embodiments, the third-party device 106 may be owned and/or operated by a third-party (i.e., an entity different than any entity owning and/or operating either the user devices 102a-n or the controller device 110). The third-party device 106 may, for example, be owned and/or operated by data and/or data service provider such as Dun & Bradstreet® Credibility Corporation (and/or a subsidiary thereof, such as Hoovers™), Deloitte® Development, LLC, Experian™ Information Solutions, Inc., and/or Edmunds.com®, Inc. In some embodiments, the third-party device 106 may supply and/or provide data such as policy information (e.g., governing state data), business and/or other classification data to the controller device 110 and/or the user devices 102a-n. In some embodiments, the third-party device 106 may comprise a plurality of devices and/or may be associated with a plurality of third-party entities.

In some embodiments, the controller device 110 may comprise an electronic and/or computerized controller device such as a computer server communicatively coupled to interface with the user devices 102a-n and/or the third-party device 106 (directly and/or indirectly). The controller device 110 may, for example, comprise one or more PowerEdge™ M910 blade servers manufactured by Dell®, Inc. of Round Rock, Tex. which may include one or more Eight-Core Intel® Xeon® 7500 Series electronic processing devices. According to some embodiments, the controller device 110 may be located remote from one or more of the user devices 102a-n and/or the third-party device 106. The controller device 110 may also or alternatively comprise a plurality of electronic processing devices located at one or more various sites and/or locations.

According to some embodiments, the controller device 110 may store and/or execute specially programmed instructions to operate in accordance with embodiments described herein. The controller device 110 may, for example, execute one or more programs that facilitate the provision of selective and/or modular data processing, process flow routing, and/or versioning, as utilized in various data processing applications, such as, but not limited to, insurance and/or risk analysis, and/or handling, processing, pricing, underwriting, and/or issuance of one or more insurance and/or underwriting products and/or claims with respect thereto. According to some embodiments, the controller device 110 may comprise a computerized processing device such as a PC, laptop computer, computer server, and/or other electronic device to manage and/or facilitate transactions and/or communications regarding the user devices 102a-n. An insurance company employee, agent, claim handler, underwriter, and/or other user (e.g., customer, consumer, client, or company) may, for example, utilize the controller device 110 to (i) price and/or underwrite one or more products, such as insurance, indemnity, and/or surety products (e.g., based on selective and/or modular data processing process flow routing and/or versioning) and/or (ii) provide an interface via which an data processing and/or underwriting entity may manage and/or facilitate modular data processing such as underwriting of various products (e.g., in a selective, modular, and/or versioned manner, in accordance with embodiments described herein).

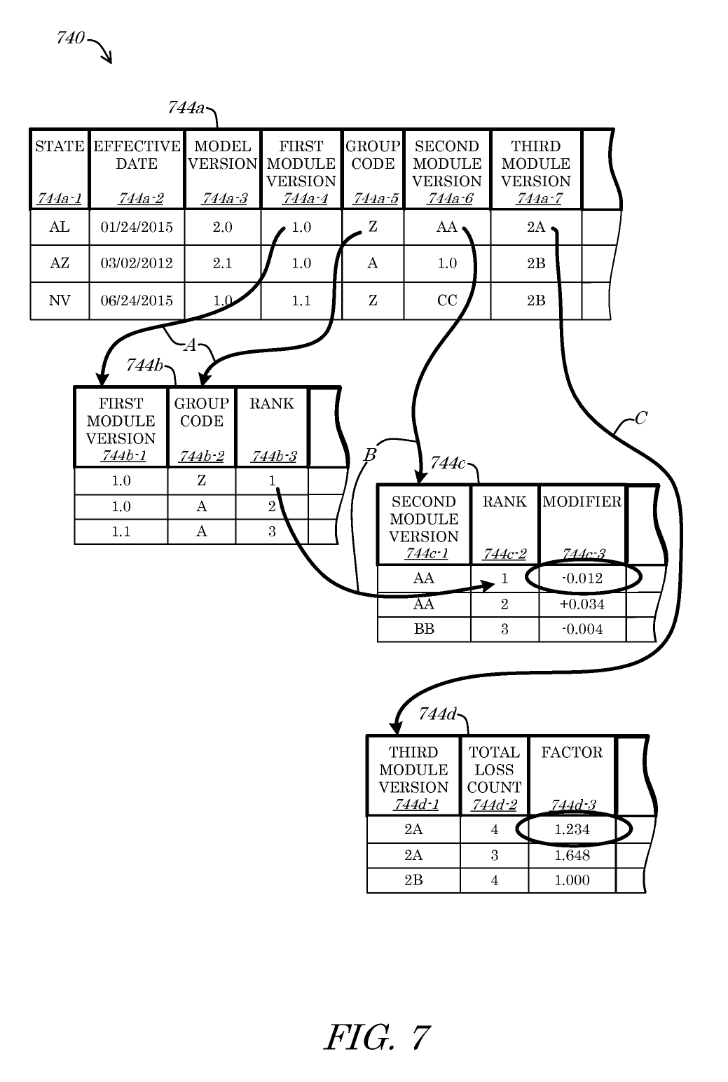

In some embodiments, the controller device 110 and/or the third-party device 106 (and/or the user devices 102a-n) may be in communication with the database 140. The database 140 may store, for example, policy data, business classification data, and/or location data obtained from the user devices 102a-n, business classification/reclassification and/or policy data defined by the controller device 110, and/or instructions that cause various devices (e.g., the controller device 110 and/or the user devices 102a-n) to operate in accordance with embodiments described herein. The database 140 may store, for example, a steering or control/routing table as described herein, and/or one or more tables storing data segmented by data processing module version information (e.g., the example data tables 744a-d of FIG. 7 herein). In some embodiments, the database 140 may comprise any type, configuration, and/or quantity of data storage devices that are or become known or practicable. The database 140 may, for example, comprise an array of optical and/or solid-state hard drives configured to store policy and/or location data provided by (and/or requested by) the user devices 102a-n, business classification data, business reclassification data, and/or process routing and/or versioning data, and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n or third-party device 106 may comprise the database 140 or a portion thereof, for example, and/or the controller device 110 may comprise the database or a portion thereof.

Referring now to FIG. 2, a flow diagram of a method 200 according to some embodiments is shown. In some embodiments, the method 200 may be performed and/or implemented by and/or otherwise associated with one or more specialized and/or specially-programmed computers (e.g., the user devices 102a-n, the third-party device 106, and/or the controller device 110, all of FIG. 1), computer terminals, computer servers, computer systems and/or networks, and/or any combinations thereof (e.g., by one or more data processing, insurance company, and/or underwriter computers).

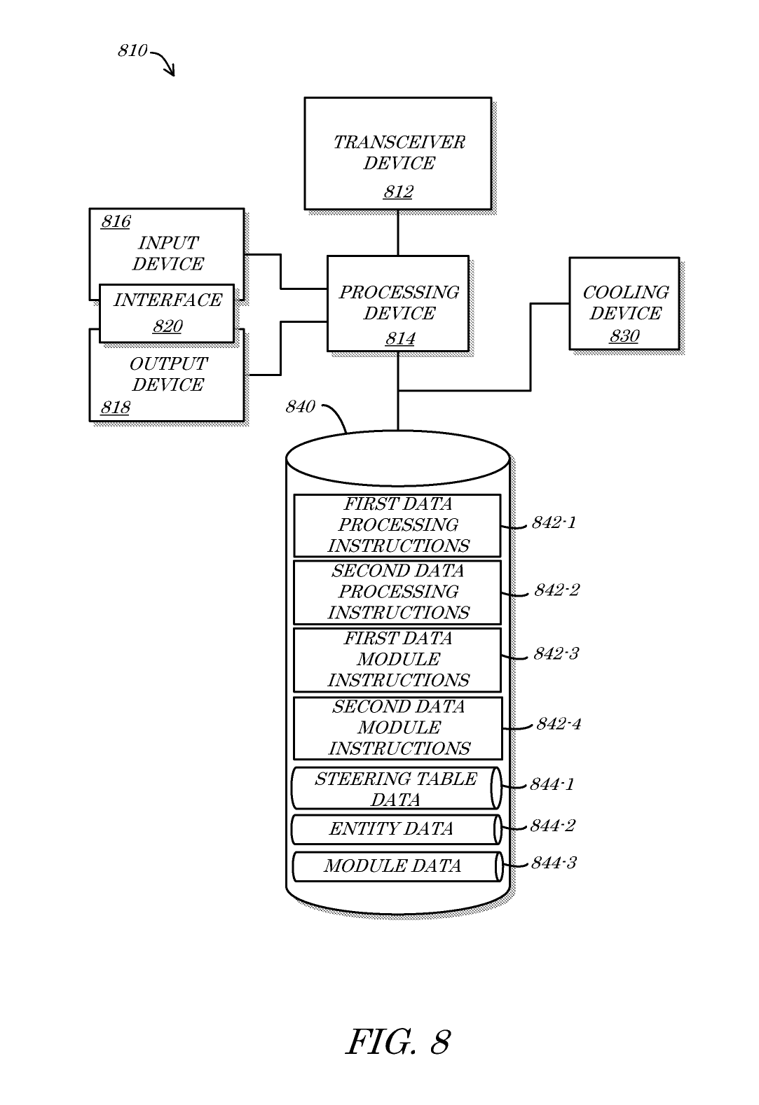

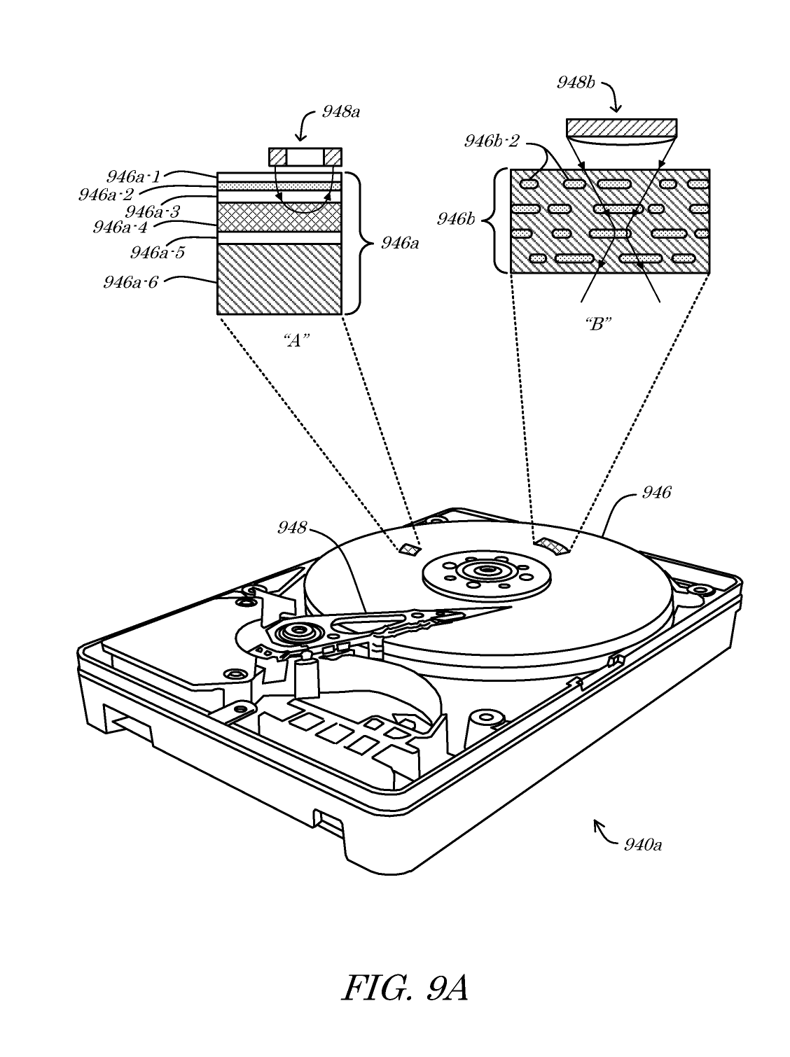

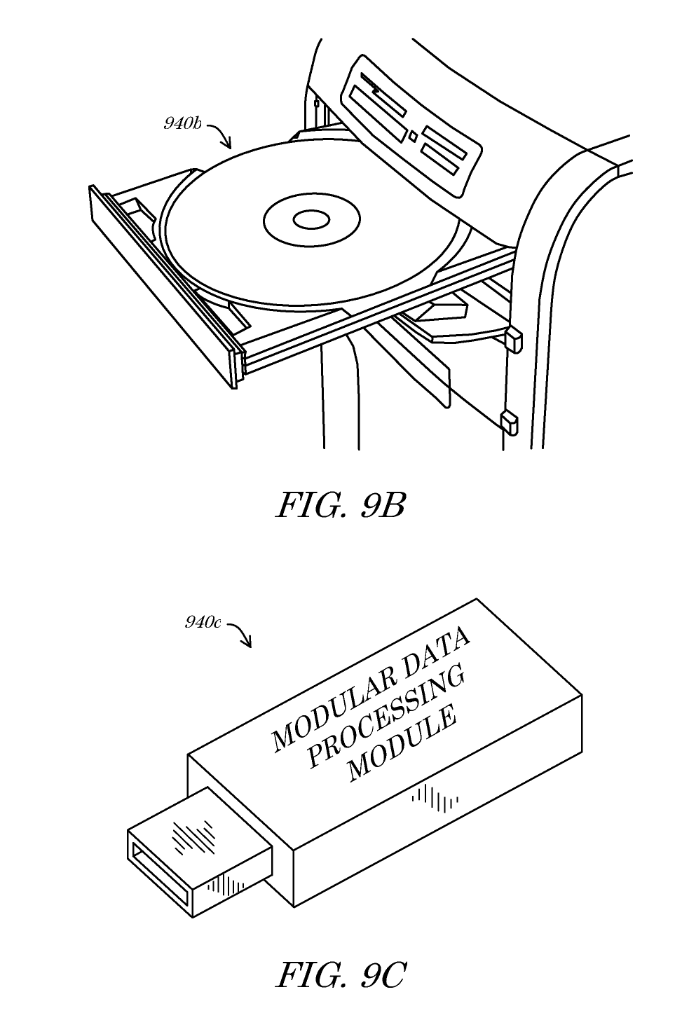

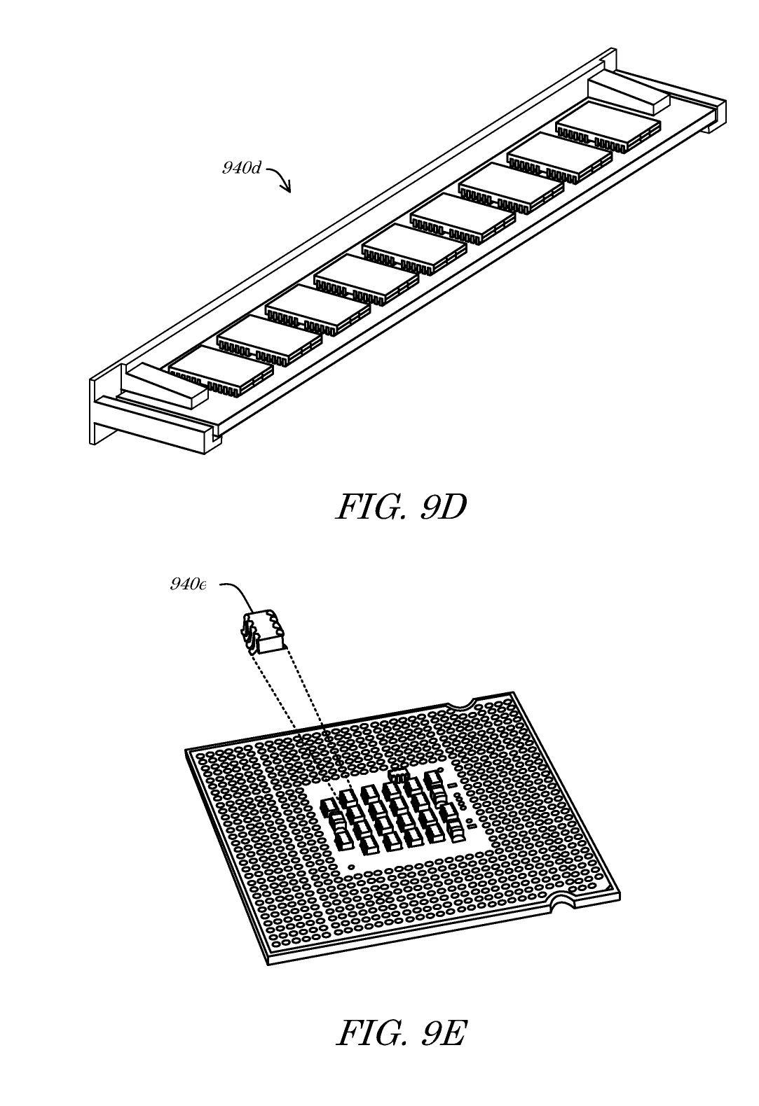

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the data storage devices 140, 740, 840, 940a-e of FIG. 1, FIG. 7, FIG. 8, FIG. 9A, FIG. 9B, FIG. 9C, FIG. 9D, and/or FIG. 9E herein) may store thereon instructions that when executed by a machine (such as a computerized processor) result in performance according to any one or more of the embodiments described herein.

According to some embodiments, the method 200 may comprise one or more actions associated with entity data 202a-n. The entity data 202a-n of one or more entities, objects, and/or areas that may be related to and/or otherwise associated with a data processing action, such as insurance data processing for an insurance territory, account, customer, insurance product, and/or policy, for example, may be determined, calculated, looked-up, retrieved, received, and/or derived. In some embodiments, the entity data 202a-n may be gathered as raw data directly from one or more data sources.

As depicted in FIG. 2, entity data 202a-n from a plurality of data sources may be gathered. In some embodiments, the entity data 202a-n may comprise information indicative of various types of perils, risks, geo-spatial data, business data, customer and/or consumer data, and/or other data that is or becomes useful or desirable for the conducting of various data processing and/or insurance process flow routing and/or versioning (e.g., governing state data, policy effective and/or expiration date data, business classification data, geospatial data, etc.), risk assessment, and/or underwriting processes. The entity data 202a-n may comprise, for example, business location data and/or governing state data, business classification data (e.g., acquired and/or derived from one or more third-party sources), business characteristic data (e.g., annual sales, receipts, payroll, square footage of business operations space), policy and/or desired policy data (e.g., effective date, expiration date, renewal date), etc. The entity data 202a-n may be acquired from any quantity and/or type of available source that is or becomes desired and/or practicable, such as from one or more sensors, databases, and/or third-party devices. In some embodiments, the entity data 202a-n may comprise geospatial and/or geo-coded data relating various peril metrics to one or more geographic locations. In some embodiments, the entity data 202a-n may comprise business classification risk, ranking, and/or scoring data utilized to effectuate business classification processes. In some embodiments, the entity data 202a-n may comprise policy effective date, policy expiration date, and/or governing state data, such as to inform selective and/or modular data processing process flow routing and/or versioning, as described herein.

According to some embodiments, the method 200 may also or alternatively comprise one or more actions associated with data processing 210. As depicted in FIG. 2, for example, some or all of the entity data 202a-n may be determined, gathered, transmitted and/or received, and/or otherwise obtained for data processing 210. In some embodiments, data processing 210 may comprise aggregation, analysis, calculation, filtering, conversion, encoding and/or decoding (including encrypting and/or decrypting), sorting, ranking, de-duping, and/or any combinations thereof. In some embodiments, data processing 210 may comprise a determination of appropriate data processing model (e.g., insurance process) flow routing and/or versioning, such as based on preliminary entity data (e.g., entity characteristic and/or location data).

According to some embodiments, a processing device may execute specially programmed instructions to process (e.g., the data processing 210) the entity data 202a-n to define one or more business classifications applicable to a business and/or to select a business classification from a plurality of possible and/or applicable business classifications.

In some embodiments, the method 200 may also or alternatively comprise one or more actions associated with insurance underwriting 220 (or some other result-oriented data processing model). Insurance underwriting 220 may generally comprise any type, variety, and/or configuration of underwriting process and/or functionality that is or becomes known or practicable. Insurance underwriting 220 may comprise, for example, simply consulting a pre-existing rule, criteria, and/or threshold to determine if an insurance product may be offered, underwritten, and/or issued to clients, based on any relevant entity data 202a-n. According to some embodiments, one of a plurality of available versions of underwriting (or other data processing) rules may be selected based on selective and/or modular data processing process flow versioning. One example of an insurance underwriting 220 process may comprise one or more of a risk assessment 230 and/or a premium calculation 240 (e.g., as shown in FIG. 2). In some embodiments, while both the risk assessment 230 and the premium calculation 240 are depicted as being part of an exemplary insurance underwriting 220 procedure, either or both of the risk assessment 230 and the premium calculation 240 may alternatively be part of a different process and/or different type of process (and/or may not be included in the method 200, as is or becomes practicable and/or desirable). Similarly, while both the risk assessment 230 and the premium calculation 240 are depicted as discrete items or objects, either or both of the risk assessment 230 and the premium calculation 240 may comprise a plurality of different items and/or objects, such as different versions of stored rules, logic, and/or process definitions. In some embodiments, the entity data 202a-n may be utilized in the insurance underwriting 220 and/or portions or processes thereof (the entity data 202a-n may be utilized, at least in part for example, to determine, define, identify, recommend, and/or select a coverage type and/or limit and/or type and/or configuration of underwriting product).

In some embodiments, the entity data 202a-n and/or a result of the insurance data processing 210 may be determined and utilized to conduct the risk assessment 230 for any of a variety of purposes. In some embodiments, the risk assessment 230 may be conducted as part of a rating process for determining how to structure an insurance product and/or offering. A “risk rating engine” utilized in an insurance underwriting process may, for example, retrieve a risk metric (e.g., provided as a result of the insurance data processing 210) for input into a calculation (and/or series of calculations and/or a mathematical model) to determine a level of risk or the amount of risky behavior likely to be associated with a particular object and/or area (e.g., being associated with one or more particular perils). In some embodiments, the risk assessment 230 may comprise determining that a client views and/or utilizes insurance data (e.g., made available to the client via the insurance company and/or a third-party). In some embodiments, the risk assessment 230 (and/or the method 200) may comprise providing risk control recommendations (e.g., recommendations and/or suggestions directed to reduction of risk, premiums, loss, etc.).

According to some embodiments, the method 200 may also or alternatively comprise one or more actions associated with premium calculation 240 (e.g., which may be part of the insurance underwriting 220). In the case that the method 200 comprises the insurance underwriting 220 process, for example, the premium calculation 240 may be utilized by a “pricing engine” to calculate (and/or look-up or otherwise determine) an appropriate premium to charge for an insurance policy associated with the object and/or area for which the insurance data 202a-n was collected and for which the risk assessment 230 was performed. In some embodiments, the entity, object, and/or area analyzed may comprise an object and/or area for which an insurance product is sought (e.g., the analyzed object may comprise a property for which a property insurance policy is desired or a business for which business insurance is desired). According to some embodiments, the entity, object, and/or area analyzed may be an object and/or area other than the object and/or area for which insurance is sought (e.g., the analyzed object and/or area may comprise a levy or drainage pump in proximity to the property for which the business insurance policy is desired).

In some embodiments, the “pricing engine” may be defined by a set of data processing instructions. The data processing instructions may, in some embodiments, determine various aspects and/or attributes or results associated with pricing of an insurance product (e.g., for the entity described by the entity data 202a-n). The data processing instructions may, for example, define which entities (e.g., based on the entity data 202a-n) are (i) offered insurance products, (ii) not offered insurance products, (iii) which types of insurance products are offered, and/or (iv) which version of one or more data processing modules (and/or data tables associated therewith) should be utilized to model pricing and/or attributes of offered products (e.g., utilizing the steering table and/or modular instructions as described herein).

According to some embodiments, the method 200 may also or alternatively comprise one or more actions associated with insurance policy quote and/or issuance 250. Once a policy has been rated, priced, or quoted (e.g., in accordance with selective and/or modular data processing process flow routing and/or versioning) and the customer/client has accepted the coverage terms, the insurance company may, for example, bind and issue the policy by hard copy and/or electronically to the client/insured. In some embodiments, the quoted and/or issued policy may comprise a personal insurance policy, such as a property damage and/or liability policy, and/or a business insurance policy, such as a business liability policy, and/or a property damage policy.

In general, a client/customer may visit a website (or a particular version thereof, such as selected based on preliminary entity information) and/or an insurance agent may, for example, provide the needed information about the client and type of desired insurance, and request an insurance policy and/or product (e.g., in accordance with various versions of applicable rules, such as a version automatically selected based on preliminary entity information). According to some embodiments, the insurance underwriting 220 may be performed utilizing information about the potential client and the policy may be issued as a result thereof. Insurance coverage may, for example, be evaluated, rated, priced, and/or sold to one or more clients, at least in part, based on the entity data 202a-n. In some embodiments, an insurance company may have the potential client indicate electronically, on-line, or otherwise whether they have any peril-sensing and/or location-sensing (e.g., telematics) devices (and/or which specific devices they have) and/or whether they are willing to install them or have them installed. In some embodiments, this may be done by check boxes, radio buttons, or other form of data input/selection, on a web page and/or via a mobile device application.

In some embodiments, the method 200 may comprise telematics data gathering, at 252. In the case that a client desires to have telematics data monitored, recorded, and/or analyzed, for example, not only may such a desire or willingness affect policy pricing (e.g., affect the premium calculation 240), but such a desire or willingness may also cause, trigger, and/or facilitate the transmitting and/or receiving, gathering, retrieving, and/or otherwise obtaining entity data 202a-n from one or more telematics devices. As depicted in FIG. 2, results of the telematics data gathering at 252 may be utilized to affect the insurance data processing 210, the risk assessment 230, and/or the premium calculation 240 (and/or otherwise may affect the insurance underwriting 220).

According to some embodiments, the method 200 may also or alternatively comprise one or more actions associated with claims 260. In the insurance context, for example, after an insurance product is provided and/or policy is issued (e.g., via the insurance policy quote and issuance 250), and/or during or after telematics data gathering 252, one or more insurance claims 260 may be filed against the product/policy. In some embodiments, such as in the case that a first entity or object associated with the insurance policy is somehow involved with one or more insurance claims 260, the entity data 202a-n of the entity or object or related objects may be gathered and/or otherwise obtained. According to some embodiments, such entity data 202a-n may comprise data indicative of a level of risk of the entity, object, and/or area (or area in which the object was located) at the time of casualty or loss (e.g., as defined by the one or more claims 260). Information on claims 260 may be provided to the data processing 210, risk assessment 230, and/or premium calculation 240 to update, improve, and/or enhance these procedures and/or associated software and/or devices. In some embodiments, entity data 202a-n may be utilized to determine, inform, define, and/or facilitate a determination or allocation of responsibility related to a loss (e.g., the entity data 202a-n may be utilized to determine an allocation of weighted liability amongst those involved in the incident(s) associated with the loss).

In some embodiments, the method 200 may also or alternatively comprise insurance policy renewal review 270. Entity data 202a-n (and/or associated business classification data) may be utilized, for example, to determine if and/or how (e.g., via which data processing and/or insurance process flow version) an existing insurance policy (e.g., provided via the insurance policy quote and issuance 250) may be renewed. According to some embodiments, such as in the case that a client is involved with and/or in charge of (e.g., responsible for) providing the entity data 202a-n (e.g., such as location data indicative of one or more particular property, building, and/or structure attributes), a review may be conducted to determine if the correct amount, frequency, and/or type or quality of the entity data 202a-n was indeed provided by the client during the original term of the policy. In the case that the entity data 202a-n was lacking, the policy may not, for example, be renewed and/or any discount received by the client for providing the entity data 202a-n may be revoked or reduced. In some embodiments, the client may be offered a discount for having certain sensing devices or being willing to install them or have them installed (or be willing to adhere to certain thresholds based on measurements from such devices). In some embodiments, analysis of the received entity data 202a-n in association with the policy may be utilized to determine if the client conformed to various criteria and/or rules set forth in the original policy. In the case that the client satisfied applicable policy requirements (e.g., as verified by received entity data 202a-n), the policy may be eligible for renewal and/or discounts. In the case that deviations from policy requirements are determined (e.g., based on the entity data 202a-n), the policy may not be eligible for renewal, a different policy may be applicable, and/or one or more surcharges and/or other penalties may be applied.

According to some embodiments, the method 200 may comprise one or more actions associated with risk/loss control 280. Any or all data (e.g., entity data 202a-n and/or other data) gathered as part of a process for claims 260, for example, may be gathered, collected, and/or analyzed to determine how (if at all) one or more of a risk rating engine (e.g., the risk assessment 230), a pricing engine (e.g., the premium calculation 240), the insurance underwriting 220, and/or the data processing 210, should be updated to reflect actual and/or realized risk, costs, and/or other issues associated with the insurance data 202a-n. Results of the risk/loss control 280 may, according to some embodiments, be fed back into the method 200 to refine the risk assessment 230, the premium calculation 240 (e.g., for subsequent insurance queries and/or calculations), the insurance policy renewal review 270 (e.g., a re-calculation of an existing policy for which the one or more claims 260 were filed), and/or the data processing 210 to appropriately scale the output of the risk assessment 230.

Referring now to FIG. 3, a flow diagram of a method 300 according to some embodiments is shown. In some embodiments, the method 300 may comprise risk assessment method which may, for example, be described as a “risk rating engine”. According to some embodiments, the method 300 may be implemented, facilitated, and/or performed by or otherwise associated with the system 100 of FIG. 1 herein. In some embodiments, the method 300 may be associated with the method 200 of FIG. 2. The method 300 may, for example, comprise a portion of the method 200 such as the risk assessment 230.

According to some embodiments, the method 300 may comprise determining one or more loss frequency distributions for a class of objects, at 302 (e.g., 302a-b). In some embodiments, a first loss frequency distribution may be determined, at 302a, based on a first parameter, data and/or metric. Data processing input and/or Insurance data (such as the entity data 202a-n of FIG. 2 and/or a portion thereof) for a class of entities and/or objects such as a class of business and/or for a particular type of business (such as an IT networking services company) within a class of objects (such as IT services) may, for example, be analyzed to determine relationships between various data and/or metrics and empirical data descriptive of actual insurance losses for such business types and/or classes of business. A risk processing and/or analytics system and/or device (e.g., the controller device 110 as described with respect to FIG. 1 herein) may, according to some embodiments, conduct regression and/or other mathematical analysis on various risk metrics to determine and/or identify mathematical relationships that may exist between such metrics and actual sustained losses and/or casualties.

Similarly, at 302b, a second loss frequency distribution may be determined based on a second parameter for the class of objects. According to some embodiments, the determining at 302b may comprise a standard or typical loss frequency distribution utilized by an entity (such as an insurance company) to assess risk. The second parameter and/or parameters utilized as inputs in the determining at 302b may include, for example, age of a building, proximity to emergency services, etc. In some embodiments, the loss frequency distribution determinations at 302a-b may be combined and/or determined as part of a single comprehensive loss frequency distribution determination. In such a manner, for example, expected total loss probabilities (e.g., taking into account both first parameter and second parameter data) for a particular object type and/or class may be determined. In some embodiments, this may establish and/or define a baseline, datum, average, and/or standard with which individual and/or particular risk assessments may be measured.

According to some embodiments, the method 300 may comprise determining one or more loss severity distributions for a class of objects, at 304 (e.g., 304a-b). In some embodiments, a first loss severity distribution may be determined, at 304a, based on the first parameter for the class of objects. Business classification data (such as the entity data 202a-n of FIG. 2) for a class of objects such as location objects and/or for a particular type of object (such as a drycleaner) may, for example, be analyzed to determine relationships between various first parameter metrics and empirical data descriptive of actual insurance losses for such object types and/or classes of objects. A risk processing and/or analytics system (e.g., the controller device 110 as described with respect to FIG. 1) may, according to some embodiments, conduct regression and/or other analysis on various metrics to determine and/or identify mathematical relationships that may exist between such metrics and actual sustained losses and/or casualties.

Similarly, at 304b, a second loss severity distribution may be determined based on the second parameter for the class of objects. According to some embodiments, the determining at 304b may comprise a standard or typical loss severity distribution utilized by an entity (such as an insurance agency) to assess risk. The second parameter and/or parameters utilized as inputs in the determining at 304b may include, for example, cost of replacement or repair, ability to self-mitigate loss (e.g., if a building has a fire suppression system and/or automatically closing fire doors, floor drains), etc. In some embodiments, the loss severity distribution determinations at 304a-b may be combined and/or determined as part of a single comprehensive loss severity distribution determination. In such a manner, for example, expected total loss severities (e.g., taking into account both first parameter and second parameter data) for a particular object type and/or class may be determined. In some embodiments, this may also or alternatively establish and/or define a baseline, datum, average, and/or standard with which individual and/or particular risk assessments may be measured.

In some embodiments, the method 300 may comprise determining one or more expected loss frequency distributions for a specific object (and/or account or other group of objects) in the class of objects, at 306 (e.g., 306a-b). Regression and/or other mathematical analysis performed on the first parameter loss frequency distribution derived from empirical data, at 302a for example, may identify various first parameter metrics and may mathematically relate such metrics to expected loss occurrences (e.g., based on historical trends). Based on these relationships, a first parameter loss frequency distribution may be developed at 306a for the specific object (and/or account or other group of objects). In such a manner, for example, known first parameter metrics for a specific object (and/or account or other group of objects) may be utilized to develop an expected distribution (e.g., probability) of occurrence of first parameter-related loss for the specific object (and/or account or other group of objects).

Similarly, regression and/or other mathematical analysis performed on the second parameter loss frequency distribution derived from empirical data, at 302b for example, may identify various second parameter metrics and may mathematically relate such metrics to expected loss occurrences (e.g., based on historical trends). Based on these relationships, a second parameter loss frequency distribution may be developed at 306b for the specific object (and/or account or other group of objects). In such a manner, for example, known second parameter metrics for a specific object may be utilized to develop an expected distribution (e.g., probability) of occurrence of second parameter-related loss for the specific object (and/or account or other group of objects). In some embodiments, the second parameter loss frequency distribution determined at 306b may be similar to a standard or typical loss frequency distribution utilized by an insurer to assess risk.

In some embodiments, the method 300 may comprise determining one or more expected loss severity distributions for a specific object (and/or account or other group of objects) in the class of objects, at 308 (e.g., 308a-b). Regression and/or other mathematical analysis performed on the first parameter loss severity distribution derived from empirical data, at 304a for example, may identify various first parameter risk metrics and may mathematically relate such metrics to expected loss severities (e.g., based on historical trends). Based on these relationships, a first parameter loss severity distribution may be developed at 308a for the specific object (and/or account or other group of objects). In such a manner, for example, known first parameter metrics for a specific object (and/or account or other group of objects) may be utilized to develop an expected severity for occurrences of first parameter-related loss for the specific object (and/or account or other group of objects).

Similarly, regression and/or other mathematical analysis performed on the second parameter loss severity distribution derived from empirical data, at 304b for example, may identify various second parameter metrics and may mathematically relate such metrics to expected loss severities (e.g., based on historical trends). Based on these relationships, a second parameter loss severity distribution may be developed at 308b for the specific object (and/or account or other group of objects). In such a manner, for example, known second parameter metrics for a specific object (and/or account or other group of objects) may be utilized to develop an expected severity of occurrences of second parameter-related loss for the specific object (and/or account or other group of objects). In some embodiments, the second parameter loss severity distribution determined at 308b may be similar to a standard or typical loss frequency distribution utilized by an insurer to assess risk.

It should also be understood that the first parameter-based determinations 302a, 304a, 306a, 308a and second parameter-based determinations 302b, 304b, 306b, 308b are separately depicted in FIG. 3 for ease of illustration of one embodiment descriptive of how risk metrics may be included to enhance standard risk assessment procedures. According to some embodiments, the first parameter-based determinations 302a, 304a, 306a, 308a and second parameter-based determinations 302b, 304b, 306b, 308b may indeed be performed separately and/or distinctly in either time or space (e.g., they may be determined by different software and/or hardware modules, versions, or components and/or may be performed serially with respect to time). In some embodiments, the first parameter-based determinations 302a, 304a, 306a, 308a and second parameter-based determinations 302b, 304b, 306b, 308b may be incorporated into a single risk assessment process or “engine” that may, for example, comprise a risk assessment software program, package, and/or model. According to some embodiments either or both of the first parameter and second parameter may comprise a plurality of parameters, variables, and/or metrics. According to some embodiments, the first parameter-based determinations 302a, 304a, 306a, 308a and second parameter-based determinations 302b, 304b, 306b, 308b may be characterized as first and second versions of risk analysis, respectively. According to some embodiments, a first user request for an underwriting product may be processed in accordance with the first parameter-based determinations 302a, 304a, 306a, 308a while a second user request for an underwriting product may be processed in accordance with the second parameter-based determinations 302b, 304b, 306b, 308b. The different user requests may, for example, be distinguished and/or trigger the different routing and/or versioning based on different preliminary entity information such as different governing states, different policy effective dates, different policy expiration dates, and/or different business classifications.

In some embodiments, the method 300 may comprise calculating a risk score (e.g., for an entity, object, account, and/or group of objects—e.g., objects related in a manner other than sharing an identical or similar class designation), at 310. According to some embodiments, formulas, charts, and/or tables may be developed that associate various first parameter and/or second parameter metric magnitudes with risk scores. Risk scores for a plurality of first parameter and/or second parameter metrics may be determined, calculated, tabulated, and/or summed to arrive at a total risk score for an object and/or account (e.g., a business, a property, a property feature, a portfolio and/or group of properties and/or objects subject to a particular risk) and/or for an object class. According to some embodiments, risk scores may be derived from the first parameter and/or second parameter loss frequency distributions and the first parameter and/or second parameter loss severity distribution determined at 306a-b and 308a-b, respectively. More details on one method for assessing risk are provided in commonly-assigned U.S. Pat. No. 7,330,820 entitled “PREMIUM EVALUATION SYSTEMS AND METHODS,” which issued on Feb. 12, 2008, the risk assessment concepts and descriptions of which are hereby incorporated by reference herein.

In some embodiments, the method 300 may also or alternatively comprise providing various recommendations, suggestions, guidelines, and/or rules directed to reducing and/or minimizing risk, premiums, etc. According to some embodiments, the results of the method 300 may be utilized to determine a premium for an insurance policy for, e.g., a specific entity, business, object, and/or account analyzed. Any or all of the first parameter and/or second parameter loss frequency distributions of 306a-b, the first parameter and/or second parameter loss severity distributions of 308a-b, and the risk score of 310 may, for example, be passed to and/or otherwise utilized by a premium calculation process via the node labeled “A” in FIG. 3.

Turning to FIG. 4, for example, a flow diagram of a method 400 (that may initiate at the node labeled “A”) according to some embodiments is shown. In some embodiments, the method 400 may comprise a premium determination method which may, for example, be described as a “pricing engine”. According to some embodiments, the method 400 may be implemented, facilitated, and/or performed by or otherwise associated with the system 100 of FIG. 1 herein. In some embodiments, the method 400 may be associated with the method 200 of FIG. 2. The method 400 may, for example, comprise a portion of the method 200 such as the premium calculation 240. Any other technique for calculating an insurance premium that uses insurance information described herein may be utilized, in accordance with some embodiments, as is or becomes practicable and/or desirable.

In some embodiments, the method 400 may comprise determining a pure premium, at 402. A pure premium is a basic, unadjusted premium that is generally calculated based on loss frequency and severity distributions. According to some embodiments, the first parameter and/or second parameter loss frequency distributions (e.g., from 306a-b in FIG. 3) and the first parameter and/or second parameter loss severity distributions (e.g., from 308a-b in FIG. 3) may be utilized to calculate a pure premium that would be expected, mathematically, to result in no net gain or loss for the insurer when considering only the actual cost of the loss or losses under consideration and their associated loss adjustment expenses. Determination of the pure premium may generally comprise simulation testing and analysis that predicts (e.g., based on the supplied frequency and severity distributions) expected total losses (first parameter-based and/or second parameter-based) over time. In some embodiments, different data processing versions and/or modules (as described herein) may be selected and/or executed to provide, calculate, and/or otherwise determine the pure premium at 402.

According to some embodiments, the method 400 may comprise determining an expense load, at 404. The pure premium determined at 402 does not take into account operational realities experienced by an insurer. The pure premium does not account, for example, for operational expenses such as overhead, staffing, taxes, fees, etc. Thus, in some embodiments, an expense load (or factor) is determined and utilized to take such costs into account when determining an appropriate premium to charge for an insurance product. According to some embodiments, the method 400 may comprise determining a risk load, at 406. The risk load is a factor designed to ensure that the insurer maintains a surplus amount large enough to produce an expected return for an insurance product.

According to some embodiments, the method 400 may comprise determining a total premium, at 408. The total premium may generally be determined and/or calculated by summing or totaling one or more of the pure premium, the expense load, and the risk load. In such a manner, for example, the pure premium is adjusted to compensate for real-world operating considerations that affect an insurer. In some embodiments, as described herein, different versions of data processing modules may be selected and/or executed to determine various modifiers, factors, and/or other additive and/or multiplicative parameters that may be utilized to adjust, modify, and/or alter the pure premium to determine the total premium at 408.

According to some embodiments, the method 400 may comprise grading the total premium, at 410. The total premium determined at 408, for example, may be ranked and/or scored by comparing the total premium to one or more benchmarks. In some embodiments, the comparison and/or grading may yield a qualitative measure of the total premium. The total premium may be graded, for example, on a scale of “A”, “B”, “C”, “D”, and “F”, in order of descending rank. The rating scheme may be simpler or more complex (e.g., similar to the qualitative bond and/or corporate credit rating schemes determined by various credit ratings agencies such as Standard & Poors' (S&P) Financial service LLC, Moody's Investment Service, and/or Fitch Ratings from Fitch, Inc., all of New York, N.Y.) of as is or becomes desirable and/or practicable. More details on one method for calculating and/or grading a premium are provided in commonly-assigned U.S. Pat. No. 7,330,820 entitled “PREMIUM EVALUATION SYSTEMS AND METHODS” which issued on Feb. 12, 2008, the premium calculation and grading concepts and descriptions of which are hereby incorporated by reference herein.

According to some embodiments, the method 400 may comprise outputting an evaluation, at 412. In the case that the results of the determination of the total premium at 408 are not directly and/or automatically utilized for implementation in association with an insurance product, for example, the grading of the premium at 410 and/or other data such as the risk score determined at 310 of FIG. 3 may be utilized to output an indication of the desirability and/or expected profitability of implementing the calculated premium. The outputting of the evaluation may be implemented in any form or manner that is or becomes known or practicable. One or more recommendations, graphical representations, visual aids, comparisons, and/or suggestions may be output, for example, to a device (e.g., a server and/or computer workstation) operated by an insurance underwriter and/or sales agent. One example of an evaluation comprises a creation and output of a risk matrix which may, for example, by developed utilizing Enterprise Risk Register® software which facilitates compliance with ISO 17799/ISO 27000 requirements for risk mitigation and which is available from Northwest Controlling Corporation Ltd. (NOWECO) of London, UK.

Turning now to FIG. 5, a flow diagram of a method 500 according to some embodiments is shown. In some embodiments, the method 500 may be performed and/or implemented by and/or otherwise associated with one or more specialized (e.g., specially-programmed as opposed to generally-programmed) and/or computerized processing devices (e.g., the user devices 102a-n, the third-party device 106, and/or the controller device 110, all of FIG. 1 herein), specialized computers, computer terminals, computer servers, computer systems and/or networks, and/or any combinations thereof (e.g., by one or more multi-threaded and/or multi-core processing units of an insurance company data processing system). In some embodiments, the method 500 may be embodied in, facilitated by, and/or otherwise associated with various input mechanisms and/or interfaces.

According to some embodiments, the method 500 may comprise receiving (e.g., by a processing device and/or by a transceiver device and/or via an electronic communications network) entity information, at 502. One or more remote electronic devices associated an entity may, for example, acquire entity data such as entity characteristic data and/or entity location data that is then transmitted to a transceiver device. In some embodiments, such remote electronic devices may comprise sensor devices and/or wireless or portable devices configured to sense and/or otherwise acquire entity data such as: (i) bankruptcy information for the entity, (ii) late payment information for the entity, (iii) a size and/or type or value of a building associated with the entity, (iv) a size and/or type or value of a building contents associated with the entity, (v) a type or value of a building occupancy associated with the entity, and/or (vi) a magnitude, frequency, severity, and/or type of loss associated with the entity. Such entity data may then, for example, be transmitted to a transceiver device having an electronic address (e.g., a URL address or MAC address) pre-programmed into the electronic device associated with each entity (e.g., remote from the transceiver device). In some embodiments, some or all of the entity data may be received from one or more devices not directly associated with the entity. Centralized, corporate-level, and/or enterprise data descriptive of the entity may, for example, be received from one or more internal and/or local electronic devices in communication with the transceiver device. In some embodiments, the receiving at 502 may be conducted by the transceiver device and/or an associated first processing unit, core, and/or thread.

In some embodiments, the method 500 may comprise determining (e.g., by the processing device(s)) an applicable data processing instructions version, at 504. In the case that multiple versions of data processing instructions are available for execution, for example, one of the available versions may be automatically selected, e.g., based on the entity data received at 502. In some embodiments, the entity data may be compared with and/or utilized to query data stored in a steering table which maps possible types, values, and/or combinations or occurrences of entity data with appropriate versions of the data processing instructions. According to some embodiments, the determining at 504 may be conducted by the processing device(s) and/or an associated second processing unit, core, and/or thread.

According to some embodiments, the method 500 may comprise calculating (e.g., by the processing device(s)) a base data processing result, at 506. The entity data may, for example, be analyzed in accordance with stored rules, formulas, and/or logical algorithms to define an initial or base data processing result. In an insurance context, for example, the base result may comprise a base premium calculation and/or an initial or raw risk rating determination. According to some embodiments, the calculating at 506 may be conducted by the processing device(s) and/or an associated third processing unit, core, and/or thread.

In some embodiments, the method 500 may comprise determining (e.g., by the processing device(s)) an applicable data processing module version, at 508. In the case that the selected data processing model version comprises a plurality of data processing modules, for example, it may be determined which of such modules and/or which available versions of such modules may be appropriate for initiation. In some embodiments, the selection of which modules and/or which versions of modules to initiate may be based, at least in part, on the entity data received at 502. According to some embodiments, the determining at 508 may be conducted by the processing device(s) and/or an associated fourth processing unit, core, and/or thread.

According to some embodiments, the method 500 may comprise determining (e.g., by the processing device(s)) a data processing modifier, at 510. Initiation and/or execution of a specifically selected data processing module and/or version, for example, may result in a calculation and/or determination of a modifier, factor, and/or other value applicable to the entity. According to some embodiments, the determining at 510 may be conducted by the processing device(s) and/or an associated fifth processing unit, core, and/or thread.

In some embodiments, the method 500 may comprise calculating (e.g., by the processing device(s)) a modified data processing result, at 512. The base data processing result determined at 506, for example, may be modified by utilizing the modifier (or other value) determined at 510. In some embodiments, one or more formulas or functions may be executed, utilizing both the base data processing result and the modifier, to derive, define, calculate, and/or otherwise determine (e.g., lookup) a modified value for the data processing result. In accordance with the ongoing example of insurance data processing herein, the modified result may comprise a total premium, and adjusted premium (e.g., to account for surcharges and/or discounts in accordance with the modifier) and/or an adjusted risk rating, e.g., of the entity. According to some embodiments, the calculating at 512 may be conducted by the processing device(s) and/or an associated sixth processing unit, core, and/or thread.

According to some embodiments, the method 500 may comprise outputting (e.g., by the processing device(s) and/or by the transceiver device and/or via the electronic communications network) the modified data processing result, at 514. Based on either or both of the calculation results and/or output from the calculations at 506 and/or 512, for example, one or more signals may be provided to one or more remote electronic devices. In some embodiments, such signals may comprise one or more commands that cause the data processing result(s) (e.g., the base data and/or the modified data) to be displayed on a remote device in a graphical format, such as via a Graphical User Interface (GUI). According to some embodiments, the transceiver device may provide the signals and/or commands to the remote electronic device(s) via one or more encoding and/or encryption protocols and/or may direct the output signals to particular electronic addresses pre-programmed into and/or made available to the transceiver device. In some embodiments, the outputting at 514 may be conducted by a seventh processing unit, core, and/or thread.

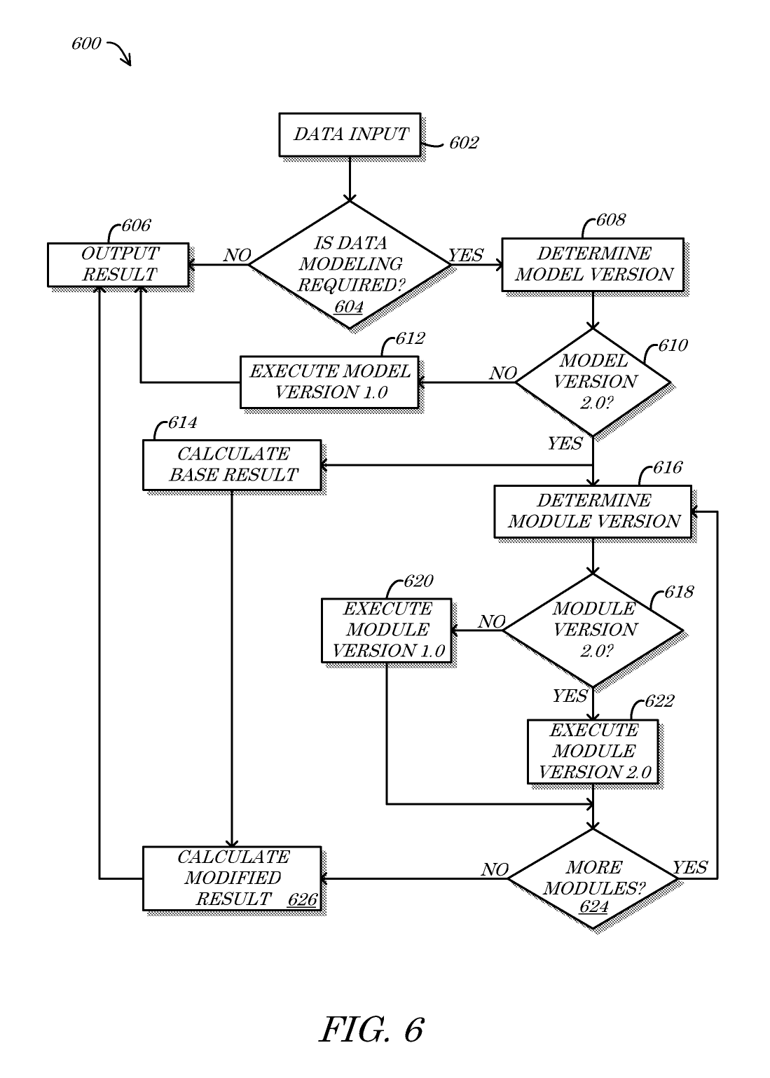

Referring now to FIG. 6, a flow diagram of a method 600 according to some embodiments is shown. In some embodiments, the method 600 may be performed and/or implemented by and/or otherwise associated with one or more specialized (e.g., specially-programmed as opposed to generally-programmed) and/or computerized processing devices (e.g., the user devices 102a-n, the third-party device 106, and/or the controller device 110, all of FIG. 1 herein), specialized computers, computer terminals, computer servers, computer systems and/or networks, and/or any combinations thereof (e.g., by one or more multi-threaded and/or multi-core processing units of an insurance company data processing system). In some embodiments, the method 600 may be embodied in, facilitated by, and/or otherwise associated with various input mechanisms and/or interfaces.

According to some embodiments, the method 600 may comprise receiving (e.g., by a processing device and/or by a transceiver device and/or via an electronic communications network) data input, at 602. The data input may, for example, comprise entity data such as entity characteristic data and/or entity location data.

In some embodiments, the method 600 may comprise determining (e.g., by the processing device(s)) whether data modeling is required, at 604. In some cases, for example, a data processing result may be simply looked up in a table and/or may be determined via application of simple stored logic that does not require a complex set of calculations or logical instructions pursuant to a data processing model. In the case that the entity comprises a large business entity, for example, no data modeling may be required to, for example, quote an insurance product to the company, as such rates may be standardized, set, and/or quickly determined by a database lookup. According to some embodiments, the determining at 604 may be conducted by the processing device(s) and/or an associated first processing unit, core, and/or thread.

According to some embodiments, in the case that the determination at 604 is negative (e.g., results in a “no”), the method 600 may proceed to output a result, at 606. According to some embodiments, the outputting (e.g., by a processing device(s) and/or by a transceiver device and/or via an electronic communications network) may comprise (e.g., in the case that no data modeling is determined to be required) an outputting of a predetermined result. In the case of insurance data processing, for example, the predetermined result may comprise a predetermined insurance quotation, premium, and/or underwriting result. Larger businesses may, for example, not need to be modeled and may accordingly be quoted certain rates and/or product features simply based on the entity data input and/or received at 602. In some embodiments, the outputting at 606 may comprise a providing or transmitting of one or more signals to one or more remote electronic devices. In some embodiments, such signals may comprise one or more commands that cause the data processing result(s) to be displayed on a remote device in a graphical format, such as via a GUI. According to some embodiments, a transceiver device may provide the signals and/or commands to the remote electronic device(s) via one or more encoding and/or encryption protocols and/or may direct the output signals to particular electronic addresses pre-programmed into and/or made available to the transceiver device. In some embodiments, the outputting at 606 may be conducted by a second processing unit, core, and/or thread.

In some embodiments, in the case that the determination at 604 is positive (e.g., results in a “yes”), the method 600 may proceed to determine a model version, at 608. Various versions of a data processing model may be available, for example, and may be selectively executed in different data scenarios. In some embodiments, different model versions may be executed based on the entity data received as input at 602. In the case that a steering table as described herein is utilized for version selection and/or determination, the steering table may comprise a number of data rows and columns that relate specific entity characteristic parameter values and/or specific entity geographic locations to specific model versions. According to some embodiments, the determining at 608 may be conducted by the processing device(s) and/or an associated third processing unit, core, and/or thread.

According to some embodiments, the method 600 may comprise determining (e.g., by the processing device(s)) whether a first specific model version (e.g., version “2.0”) should be executed, at 610. The determining at 610 may, for example, be conducted in response to and/or based on the results of the determining at 608. According to some embodiments, the determining at 610 may be conducted by the processing device(s) and/or an associated fourth processing unit, core, and/or thread.

In some embodiments, in the case that the determination at 610 is negative (e.g., results in a “no”), the method 600 may proceed to execute a second specific model version (e.g., version “1.0”), at 612. In some embodiments, for example, the second specific model version may comprise a legacy, simplified, and/or non-modular set of instructions. According to some embodiments, the entity data may, for example, be analyzed in accordance with stored rules, formulas, and/or logical algorithms defined by the second specific model version. In some embodiments, the execution of the second specific model version at 612 may cause the method 600 to proceed to the outputting of the result, at 606. According to some embodiments, the execution of the second specific model version at 612 may be conducted by the processing device(s) and/or an associated fifth processing unit, core, and/or thread.

According to some embodiments, in the case that the determination at 610 is positive (e.g., results in a “yes”), the method 600 may proceed to calculate a base result, at 614. The calculation at 614 may, for example, comprise an initialization and/or execution of the first specific model version. In some embodiments, the first specific model version may comprise a modular set of instructions that are specifically structured to allow for simplified versioning control and modification. In the case of the ongoing example of an insurance data processing system, for example, the first specific model version may comprise a shared set of instructions, execution of which will result in a determination or definition of the base result, e.g., at 614. In the ongoing example of insurance data processing, the base result may comprise a pure or base premium for one or more insurance products and/or an initial risk assessment determination or baseline. The first specific model version may also (or alternatively) comprise one or more (e.g., a plurality of) modular instruction sets programmed to calculate and/or derive specific modular data processing results. According to some embodiments, different modules and/or module versions may be executed as part of the first specific data processing model version in different data scenarios.

According to some embodiments, such in the case that the determination at 610 is positive (e.g., results in a “yes”), the method 600 may proceed to determine a module version, at 616. Various modules and/or versions of a data processing model modules may be available, for example, and may be selectively executed in different data scenarios. In some embodiments, different module versions may be executed based on the entity data received as input at 602. In the case that a steering table as described herein is utilized for version selection and/or determination, the steering table may comprise a number of data rows and columns that relate specific entity characteristic parameter values and/or specific entity geographic locations to specific modules and/or module versions. According to some embodiments, the determining at 616 may be conducted by the processing device(s) and/or an associated seventh processing unit, core, and/or thread.

In some embodiments, the method 600 may comprise determining (e.g., by the processing device(s)) whether a first specific module version (e.g., version “2.0”) should be executed, at 618. The determining at 618 may, for example, be conducted in response to and/or based on the results of the determining at 616. According to some embodiments, the determining at 618 may be conducted by the processing device(s) and/or an associated eighth processing unit, core, and/or thread.

In some embodiments, in the case that the determination at 618 is negative (e.g., results in a “no”), the method 600 may proceed to execute a second specific module version (e.g., version “1.0”), at 620. In some embodiments, for example, the second specific module version may comprise a set of instructions tailored and/or customized for a second particular data processing scenario. The second specific module version may, for example, comprise a set of programmed instructions that are customized for a second particular geographic jurisdiction, such as based on second jurisdictional regulations. According to some embodiments, the entity data may be analyzed in accordance with stored rules, formulas, and/or logical algorithms defined by the second specific module version. According to some embodiments, the execution of the second specific module version at 620 may be conducted by the processing device(s) and/or an associated ninth processing unit, core, and/or thread.

According to some embodiments, in the case that the determination at 618 is positive (e.g., results in a “yes”), the method 600 may proceed to execute a first specific module version (e.g., version “2.0”), at 622. In some embodiments, for example, the first specific module version may comprise a set of instructions tailored and/or customized for a first particular data processing scenario. The first specific module version may, for example, comprise a set of programmed instructions that are customized for a first particular geographic jurisdiction, such as based on first jurisdictional regulations. According to some embodiments, the entity data may be analyzed in accordance with stored rules, formulas, and/or logical algorithms defined by the first specific module version. According to some embodiments, the execution of the first specific module version at 622 may be conducted by the processing device(s) and/or an associated tenth processing unit, core, and/or thread.

In some embodiments, either or both of the module executions at 620 and 622 may proceed to a determination of whether any more modules should be executed as part of the overall execution of the first specific data processing model version, at 624. According to some embodiments, the determination at 624 may be conducted by the processing device(s) and/or an associated eleventh processing unit, core, and/or thread.

In the case that the determination at 624 is positive (e.g., results in a “yes”), the method 600 may proceed back to (e.g., loop back to) 616 to determine another applicable module version. Each multi-version module of a plurality of modules may, for example, provide a result, modifier, factor, and/or other data that may be utilized to influence and/or adjust the output of the data processing model. A first module may utilize a first type of data and/or algorithm to determine a first adjustment factor of a first type, for example, and a second module may utilize a second type of data and/or algorithm to determine a second adjustment factor of a second type. In some embodiments, the modules may provide modifications to the output of the data processing model associated with business parameters, including (but not limited to) one or more of third-party data (such as bankruptcy data, late payment data, etc.), insurance policy and/or entity characteristic data (such as size of building to be insured, value of building contents, occupancy/ownership type, etc.), and/or, loss information (such as frequency of loss, severity of loss, type of loss, and/or location of loss). According to some embodiments, such as in the case that only a single multi-version module is utilized, the determination at 624 may not be required. In some embodiments, a data processing model may comprise three (3) or more modules directed to determining appropriate modifiers to apply to the base result. In the case that the determination at 624 is negative (e.g., results in a “no”), the method 600 may continue to calculate a modified result, at 626. The modified result calculated at 626 may comprise, for example, execution of one or more mathematical formulas that utilize inputs, such as the base result from 614 and any applicable results from execution of any modules at 620 and/or 622. In the ongoing insurance data processing example, such as in the case that the base result from 614 comprises a base premium or initial risk assessment, the calculating at 626 may comprise modifying the base premium or initial risk assessment to define a total and/or modified premium or a final risk assessment (e.g., Risk Rating Variable (RRV)), respectively. Results from the execution of the modules at 620 and/or 622, for example, may be utilized as factors and/or modifiers to adjust and/or transform the base result into the modified result. According to some embodiments, the calculation at 626 may be conducted by the processing device(s) and/or an associated twelfth processing unit, core, and/or thread.

In some embodiments, the method 600 may proceed to output the result (e.g., the modified result) at 606. In such a manner, for example, whether data modeling is required or not, whether the first or second versions of the data processing model are appropriate for execution, and/or whether specific modules and/or versions of modules are applicable for execution as part of the first specific data model, a data processing result applicable to the entity data received as input at 602 may be output at 606. In some embodiments, the various decision points implemented in the method 600 may be effectuated by specific data structures that allow for such modularized data processing. An example of such specialized data structures, in specific context of the ongoing example of insurance data processing, is described with reference to FIG. 7 below.

### III. Data Storage Structures

Referring to FIG. 7, for example, diagrams of an example data storage structure 740 according to some embodiments are shown. In some embodiments, the data storage structure 740 may comprise a plurality of data tables, such as a steering table 744a, a first module table 744b, a second module table 744c, and/or a third module table 744d. The data tables 744a-d may, for example, be utilized in an execution of a modular data processing model, as described herein.

The steering table 744a may comprise, in accordance with some embodiments, a state field 744a-1, an effective date field 744a-2, a model version field 744a-3, a first module version field 744a-4, a group code field 744a-5, a second module version field 744a-6, and/or a third module version field 744a-7. As described herein, the data stored in the steering table 744a may be utilized to “steer” data processing down one or more specific paths, such as by specifying which version of a data model to call or implement and/or which modules within a specific data model version to execute. In such a manner, for example, as data processing requirements change, in many cases such changes may be managed simply by changing some of the data stored in the steering table 744a, as opposed to requiring time-consuming source code edits, re-compiling, and debugging. In some embodiments, the steering table 744a may be utilized to direct processing activities to one or more specific data sources and/or tables such as one or more of the other data tables 744b-d depicted in FIG. 7.

The first module table 744b may comprise, in accordance with some embodiments for example, a first module version field 744b-1, a group code field 744b-2, and/or a rank field 744b-3. The steering table 744a may direct processing to the first module version field 744b-1, for example, which may be indexed and may accordingly provide faster processing than previously utilized hard-coded and/or non-modular methods. Data storage requirements for the data storage structure 740 may also or alternatively be reduced as compared to previous data processing methodologies, such as due to utilization of the group code field 744a-5 as an index, as opposed to a plurality of previous indexed fields such as both the state field 744a-1 and the effective date field 744a-2. According to some embodiments, data defining the first module version and the group code (e.g., a state grouping code—such as for states or other jurisdictions that have a shared regulatory environment and/or feature) may be utilized to determine a rank or score via the rank field 744b-3. The rank field 744b-3 may store, for example, a credit score or ranking, such as determined via a combination of third-party and entity data.

In some embodiments, the second module table 744c may comprise a second module version field 744c-1, a rank field 744c-2, and/or a modifier field 744c-3. According to some embodiments, the steering table 744a may be utilized in conjunction with the ranking result obtained from the first module table 744b to determine an applicable modifier as stored in the modifier field 744c-3. The modifier may, for example, comprise a value that is utilized to alter, adjust, and/or modify a data processing result, such as a base premium and/or initial risk assessment value (e.g., obtained by execution of a particular version of a data processing model as selected and initiated, as described herein).

The third module table 744d may comprise, in accordance with some embodiments, a third module version field 744d-1, a total loss count field 744d-2, and/or a factor field 744d-3. According to some embodiments, the steering table 744a may be utilized to determine an applicable factor stored in the factor field 744d-3. The factor may, for example, comprise a value that is utilized to alter, adjust, and/or modify a data processing result, such as a base premium and/or initial risk assessment value (e.g., obtained by execution of a particular version of a data processing model as selected and initiated, as described herein).

In some embodiments, data processing results, such as insurance premiums and/or risk assessment parameters, may be defined in a modular programmatic fashion utilizing relationships established between two or more of the data tables 744a-d. As depicted in the example data storage structure 740, for example, a first relationship “A” may be established between the steering table 744a and the first module table 744b. In some embodiments (e.g., as depicted in FIG. 7), the first relationship “A” may be defined by utilizing the first module version field 744a-4 and/or the group code field 744a-5 as a data key linking to the first module version field 744b-1 and/or the group code field 744b-2, respectively. According to some embodiments, the first relationship “A” may comprise any type of data relationship that is or becomes desirable, such as a one-to-many, many-to-many, or many-to-one relationship. In the case that a single result from the rank field 744b-3 is desired, the first relationship “A” may comprise a one-to-one relationship. In such a manner, for example, entity data utilized to compare, query, and/or otherwise process against the steering table 744a may be utilized to determine (i) which version of the first programming module to execute, (ii) whether to execute any version of the first programming module, and/or (iii) a result of the first programming module, such as a rank or score value stored in the rank field 744b-3.

According to some embodiments, a second relationship “B” may be established between the steering table 744a, the first module table 744b, and the second module table 744c. In some embodiments (e.g., as depicted in FIG. 7), the second relationship “B” may be defined by utilizing the second module version field 744a-6 and the rank field 744b-3 as a data key linking to the second module version field 744c-1 and the rank field 744c-2, respectively. According to some embodiments, the second relationship “B” may comprise any type of data relationship that is or becomes desirable, such as a one-to-many, many-to-many, or many-to-one relationship. In the case that a single result from the modifier field 744c-3 is desired, the second relationship “B” may comprise a one-to-one relationship. In such a manner, for example, a result of the first programming module (and/or a first selected version thereof), such as a particular rank value stored in the rank field 744b-3, may be utilized in conjunction with the steering table 744a to determine (i) which version of the second programming module to execute, (ii) whether to execute any version of the second programming module, and/or (iii) a result of the second programming module, such as a modifier value stored in the modifier field 744c-3 (e.g., depicted as being circled in FIG. 7).

In some embodiments, a third relationship “C” may be established between the steering table 744a and the third module table 744d. In some embodiments (e.g., as depicted in FIG. 7), the third relationship “C” may be defined by utilizing the third module version field 744a-7 as a data key linking to the third module version field 744d-1. According to some embodiments, the third relationship “C” may comprise any type of data relationship that is or becomes desirable, such as a one-to-many, many-to-many, or many-to-one relationship. In the case that a single result from the factor field 744d-3 is desired, the third relationship “C” may comprise a one-to-one relationship. In such a manner, for example, a result of the third programming module (and/or a first selected version thereof), such as a particular total loss count value, may be utilized in conjunction with the steering table 744a to determine (i) which version of the third programming module to execute, (ii) whether to execute any version of the third programming module, and/or (iii) a result of the third programming module, such as a factor value stored in the factor field 744d-3 (e.g., depicted as being circled in FIG. 7).

In some embodiments, fewer or more data fields than are shown may be associated with the data tables 744a-d. Only a portion of one or more databases and/or other data stores is necessarily shown in FIG. 7, for example, and other database fields, columns, structures, orientations, quantities, and/or configurations may be utilized without deviating from the scope of some embodiments. Further, the data shown in the various data fields is provided solely for exemplary and illustrative purposes and does not limit the scope of embodiments described herein.

### IV. Apparatus and Articles of Manufacture

Turning to FIG. 8, a block diagram of an apparatus 810 according to some embodiments is shown. In some embodiments, the apparatus 810 may be similar in configuration and/or functionality to any of the user devices 102a-n, the third-party devices 106, and/or the controller devices 110 of FIG. 1 herein, and/or may otherwise comprise a portion of the system 100 of FIG. 1 herein. The apparatus 810 may, for example, execute, process, facilitate, and/or otherwise be associated with the methods 200, 300, 400, 500, 600 described in conjunction with FIG. 2, FIG. 3, FIG. 4, FIG. 5, and/or FIG. 6 herein, and/or one or more portions or combinations thereof. In some embodiments, the apparatus 810 may comprise a transceiver device 812, one or more processing devices 814, an input device 816, an output device 818, an interface 820, a cooling device 830, and/or a memory device 840 (storing various programs and/or instructions 842 and data 844). According to some embodiments, any or all of the components 812, 814, 816, 818, 820, 830, 840, 842, 844 of the apparatus 810 may be similar in configuration and/or functionality to any similarly named and/or numbered components described herein. Fewer or more components 812, 814, 816, 818, 820, 830, 840, 842, 844 and/or various configurations of the components 812, 814, 816, 818, 820, 830, 840, 842, 844 may be included in the apparatus 810 without deviating from the scope of embodiments described herein.

In some embodiments, the transceiver device 812 may comprise any type or configuration of bi-directional electronic communication device that is or becomes known or practicable. The transceiver device 812 may, for example, comprise a Network Interface Card (NIC), a telephonic device, a cellular network device, a router, a hub, a modem, and/or a communications port or cable. In some embodiments, the transceiver device 812 may be coupled to provide data to a user device (not shown in FIG. 8), such as in the case that the apparatus 810 is utilized to provide a data processing interface to a user and/or to provide modular data processing results, as described herein. The transceiver device 812 may, for example, comprise a cellular telephone network transmission device that sends signals indicative of modular data processing interface components and/or data processing result-based commands to a user handheld, mobile, and/or telephone device. According to some embodiments, the transceiver device 812 may also or alternatively be coupled to the processing device 814. In some embodiments, the transceiver device 812 may comprise an IR, RF, Bluetooth™ and/or Wi-Fi® network device coupled to facilitate communications between the processing device 814 and another device (such as a user device and/or a third-party device; not shown in FIG. 8).

According to some embodiments, the processing device 814 may be or include any type, quantity, and/or configuration of electronic and/or computerized processor that is or becomes known. The processing device 814 may comprise, for example, an Intel® IXP 2800 network processor or an Intel® XEON™ Processor coupled with an Intel® E7501 chipset. In some embodiments, the processing device 814 may comprise multiple inter-connected processors, microprocessors, and/or micro-engines. According to some embodiments, the processing device 814 (and/or the apparatus 810 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 810 comprises a server such as a blade server, necessary power may be supplied via a standard AC outlet, power strip, surge protector, a PDU, and/or Uninterruptible Power Supply (UPS) device (none of which are shown in FIG. 8).

In some embodiments, the input device 816 and/or the output device 818 are communicatively coupled to the processing device 814 (e.g., via wired and/or wireless connections and/or pathways) and they may generally comprise any types or configurations of input and output components and/or devices that are or become known, respectively. The input device 816 may comprise, for example, a keyboard that allows an operator of the apparatus 810 to interface with the apparatus 810 (e.g., by a user, such as an insurance company analyzing and processing insurance rate quote requests, as described herein). The output device 818 may, according to some embodiments, comprise a display screen and/or other practicable output component and/or device. The output device 818 may, for example, provide a modular data processing interface such as the interface 820 to a user (e.g., via a website). In some embodiments, the interface 820 may comprise portions and/or components of either or both of the input device 816 and the output device 818. According to some embodiments, the input device 816 and/or the output device 818 may, for example, comprise and/or be embodied in an input/output and/or single device such as a touch-screen monitor (e.g., that enables both input and output via the interface 820).

In some embodiments, the apparatus 810 may comprise the cooling device 830. According to some embodiments, the cooling device 830 may be coupled (physically, thermally, and/or electrically) to the processing device 814 and/or to the memory device 840. The cooling device 830 may, for example, comprise a fan, heat sink, heat pipe, radiator, cold plate, and/or other cooling component or device or combinations thereof, configured to remove heat from portions or components of the apparatus 810.

The memory device 840 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 840 may, according to some embodiments, store one or more of first data model instructions 842-1, second data model instructions 842-2, first data module instructions 842-3, second data module instructions 842-4, steering table data 844-1, entity data 844-2, and/or module data 844-3. In some embodiments, the first data model instructions 842-1, second data model instructions 842-2, first data module instructions 842-3, second data module instructions 842-4, steering table data 844-1, entity data 844-2, and/or module data 844-3 may be utilized by the processing device 814 to provide output information via the output device 818 and/or the transceiver device 812.

According to some embodiments, the first data processing instructions 842-1 may be operable to cause the processing device 814 to process steering table data 844-1, entity data 844-2, and/or module data 844-3. Steering table data 844-1, entity data 844-2, and/or module data 844-3 received via the input device 816 and/or the transceiver device 812 may, for example, be analyzed, sorted, filtered, decoded, decompressed, ranked, scored, plotted, and/or otherwise processed by the processing device 814 in accordance with the first data processing instructions 842-1. In some embodiments, steering table data 844-1, entity data 844-2, and/or module data 844-3 may be fed by the processing device 814 through one or more mathematical and/or statistical formulas and/or models in accordance with the first data processing instructions 842-1 to provide a data processing result based on a first version of a data processing model, such as a first version of an insurance product risk analysis and/or pricing model, in accordance with embodiments described herein.

In some embodiments, the second data processing instructions 842-2 may be operable to cause the processing device 814 to process steering table data 844-1, entity data 844-2, and/or module data 844-3. Steering table data 844-1, entity data 844-2, and/or module data 844-3 received via the input device 816 and/or the transceiver device 812 may, for example, be analyzed, sorted, filtered, decoded, decompressed, ranked, scored, plotted, and/or otherwise processed by the processing device 814 in accordance with the second data processing instructions 842-2. In some embodiments, steering table data 844-1, entity data 844-2, and/or module data 844-3 may be fed by the processing device 814 through one or more mathematical and/or statistical formulas and/or models in accordance with the second data processing instructions 842-2 to provide a data processing result based on a second version of a data processing model, such as a second version of an insurance product risk analysis and/or pricing model, in accordance with embodiments described herein. Further as described herein, the first data processing instructions 842-1 and the second data processing instructions 842-2 may be selectively executed, e.g., based on the steering table data 844-1 and the entity data 844-2.

According to some embodiments, the first data module instructions 842-3 may be operable to cause the processing device 814 to process steering table data 844-1, entity data 844-2, and/or module data 844-3. Steering table data 844-1, entity data 844-2, and/or module data 844-3 received via the input device 816 and/or the transceiver device 812 may, for example, be analyzed, sorted, filtered, decoded, decompressed, ranked, scored, plotted, and/or otherwise processed by the processing device 814 in accordance with the first data module instructions 842-3. In some embodiments, steering table data 844-1, entity data 844-2, and/or module data 844-3 may be fed by the processing device 814 through one or more mathematical and/or statistical formulas and/or models in accordance with the first data module instructions 842-3 to provide a data processing result based on a first version of a data processing model module, such as a first version of an insurance product risk analysis and/or pricing model module, in accordance with embodiments described herein.

In some embodiments, the second data module instructions 842-4 may be operable to cause the processing device 814 to process steering table data 844-1, entity data 844-2, and/or module data 844-3. Steering table data 844-1, entity data 844-2, and/or module data 844-3 received via the input device 816 and/or the transceiver device 812 may, for example, be analyzed, sorted, filtered, decoded, decompressed, ranked, scored, plotted, and/or otherwise processed by the processing device 814 in accordance with the second data module instructions 842-4. In some embodiments, steering table data 844-1, entity data 844-2, and/or module data 844-3 may be fed by the processing device 814 through one or more mathematical and/or statistical formulas and/or models in accordance with the second data module instructions 842-4 to provide a data processing result based on a second version of a data processing model module, such as a second version of an insurance product risk analysis and/or pricing model module, in accordance with embodiments described herein. Further as described herein, the first data module instructions 842-3 and the second data module instructions 842-4 may be selectively executed, e.g., based on the steering table data 844-1 and the entity data 844-2.

Any or all of the exemplary instructions 842 and data types 844 described herein and other practicable types of data may be stored in any number, type, and/or configuration of memory devices that is or becomes known. The memory device 840 may, for example, comprise one or more data tables or files (e.g., the example data tables 744a-d of FIG. 7 herein), databases, table spaces, registers, and/or other storage structures. In some embodiments, multiple databases and/or storage structures (and/or multiple memory devices 840) may be utilized to store information associated with the apparatus 810. According to some embodiments, the memory device 840 may be incorporated into and/or otherwise coupled to the apparatus 810 (e.g., as shown) or may simply be accessible to the apparatus 810 (e.g., externally located and/or situated).

Referring to FIG. 9A, FIG. 9B, FIG. 9C, FIG. 9D, and FIG. 9E, perspective diagrams of exemplary data storage devices 940a-e according to some embodiments are shown. The data storage devices 940a-e may, for example, be utilized to store instructions and/or data such as the first data model instructions 842-1, second data model instructions 842-2, first data module instructions 842-3, second data module instructions 842-4, steering table data 844-1, entity data 844-2, and/or module data 844-3, each of which is described in reference to FIG. 8 herein. In some embodiments, instructions stored on the data storage devices 940a-e may, when executed by one or more threads, cores, and/or processors (such as the processor device 814 of FIG. 8), cause the implementation of and/or facilitate the methods 200, 300, 400, 500, 600 described in conjunction with FIG. 2, FIG. 3, FIG. 4, FIG. 5, and/or FIG. 6 herein, and/or portions or combinations thereof.

According to some embodiments, a first data storage device 940a may comprise one or more various types of internal and/or external hard drives. The first data storage device 940a may, for example, comprise a data storage medium 946 that is read, interrogated, and/or otherwise communicatively coupled to and/or via a disk reading device 948. In some embodiments, the first data storage device 940a and/or the data storage medium 946 may be configured to store information utilizing one or more magnetic, inductive, and/or optical means (e.g., magnetic, inductive, and/or optical-encoding). The data storage medium 946, depicted as a first data storage medium 946a for example (e.g., breakout cross-section “A”), may comprise one or more of a polymer layer 946a-1, a magnetic data storage layer 946a-2, a non-magnetic layer 946a-3, a magnetic base layer 946a-4, a contact layer 946a-5, and/or a substrate layer 946a-6. According to some embodiments, a magnetic read head 946a may be coupled and/or disposed to read data from the magnetic data storage layer 946a-2.

In some embodiments, the data storage medium 946, depicted as a second data storage medium 946b for example (e.g., breakout cross-section “B”), may comprise a plurality of data points 946b-2 disposed with the second data storage medium 946b. The data points 946b-2 may, in some embodiments, be read and/or otherwise interfaced with via a laser-enabled read head 948b disposed and/or coupled to direct a laser beam through the second data storage medium 946b.

In some embodiments, a second data storage device 940b may comprise a CD, CD-ROM, DVD, Blu-Ray™ Disc, and/or other type of optically-encoded disk and/or other storage medium that is or becomes know or practicable. In some embodiments, a third data storage device 940c may comprise a USB keyfob, dongle, and/or other type of flash memory data storage device that is or becomes know or practicable. In some embodiments, a fourth data storage device 940d may comprise RAM of any type, quantity, and/or configuration that is or becomes practicable and/or desirable. In some embodiments, the fourth data storage device 940d may comprise an off-chip cache such as a Level 2 (L2) cache memory device. According to some embodiments, a fifth data storage device 940e may comprise an on-chip memory device such as a Level 1 (L1) cache memory device.

The data storage devices 940a-e may generally store program instructions, code, and/or modules that, when executed by a processing device cause a particular machine to function in accordance with one or more embodiments described herein. The data storage devices 940a-e depicted in FIG. 9A, FIG. 9B, FIG. 9C, FIG. 9D, and FIG. 9E are representative of a class and/or subset of computer-readable media that are defined herein as “computer-readable memory” (e.g., non-transitory memory devices as opposed to transmission devices or media).

The terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable medium” and/or “tangible media” specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined above and includes many exemplary protocols that are also applicable here.

### V. Terms and Rules of Interpretation

Throughout the description herein and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. While not generally limiting and while not limiting for all described embodiments, in some embodiments, the terms are specifically limited to the example definitions and/or examples provided. Other terms are defined throughout the present description.

Some embodiments described herein are associated with a “module”. As utilized herein, the term “module” may generally be descriptive of any combination of hardware, electronic circuitry and/or other electronics (such as logic chips, logical gates, and/or other electronic circuit elements or components), hardware (e.g., physical devices such as hard disks, solid-state memory devices, and/or computer components such as processing units or devices), firmware, and/or software or microcode.

Some embodiments described herein are associated with a “user device”, a “remote device”, or a “network device”. As used herein, each of a “user device” and a “remote device” is a subset of a “network device”. The “network device”, for example, may generally refer to any device that can communicate via a network, while the “user device” may comprise a network device that is owned and/or operated by or otherwise associated with a particular user (and/or group of users—e.g., via shared login credentials and/or usage rights), and while a “remote device” may generally comprise a device remote from a primary device or system component and/or may comprise a wireless and/or portable network device. Examples of user, remote, and/or network devices may include, but are not limited to: a PC, a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. User, remote, and/or network devices may, in some embodiments, comprise one or more network components.

As used herein, the term “network component” may refer to a user, remote, or network device, or a component, piece, portion, or combination of user, remote, or network devices. Examples of network components may include a Static Random Access Memory (SRAM) device or module, a network processor, and a network communication path, connection, port, or cable.

In addition, some embodiments are associated with a “network” or a “communication network.” As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

The term “indication”, as used herein (unless specified otherwise), may generally refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination

In some embodiments, one or more specialized machines such as a computerized processing device, a server, a remote terminal, and/or a customer device may implement the various practices described herein. A computer system of an insurance quotation and/or risk analysis processing enterprise may, for example, comprise various specialized computers that interact to analyze, process, and/or transform data in a modular fashion as described herein. In some embodiments, such modular data processing may provide various advantages such as reducing the number and/or frequency of data calls to data storage devices, which may accordingly increase processing speeds for instances of data processing model executions. As the modular approach detailed herein also allows for storage of a single, modular set of programming code as opposed to multiple complete version of code having variance therein, the taxation on memory resources for a data processing system may also be reduced.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicant reserves the right to file additional applications to pursue patents for subject matter that has been disclosed and enabled, but not claimed in the present application.

What is claimed is:

1. A data processing system, comprising:
a plurality of electronic processing devices;
an electronic communications network transceiver device in communication with the plurality of electronic processing devices; and
a memory device in communication with the plurality of electronic processing devices, the memory device storing (1) data processing model instructions and (2) a data processing model steering table, wherein the data processing model instructions, when executed by the plurality of electronic processing devices, result in:
(i) receiving as input, via the electronic communications network transceiver device, data descriptive of (a) a characteristic of an entity and (b) a geographic location of the entity;
(ii) determining, based on a first comparison of (a) the characteristic of the entity and (b) the geographic location of the entity with data stored in the data processing model steering table, which one of a plurality of versions of the data processing model instructions is applicable to the entity;
(iii) determining, by an execution of the one of the plurality of versions of the data processing model instructions determined to be applicable to the entity, a data processing result for the entity; and
(iv) outputting, by the electronic communications network transceiver device, an indication of the data processing result for the entity.

2. The data processing system of claim 1, wherein the data processing model instructions, when executed by the plurality of electronic processing devices, further result in:
determining, based on a second comparison of (a) the characteristic of the entity and (b) the geographic location of the entity with data stored in the data processing model steering table, which one of a plurality of versions of a first specific module of the data processing model instructions is applicable to the entity; and
determining, by accessing a first data table associated with the first specific module of the data processing instructions, and based on which one of the plurality of versions of the first specific module of the data processing model instructions is determined to be applicable to the entity, a rank for the entity.

3. The data processing system of claim 2, wherein the rank for the entity comprises a credit rating tier.

4. The data processing system of claim 2, wherein the data processing model instructions, when executed by the plurality of electronic processing devices, further result in:
determining, based on a third comparison of (a) the characteristic of the entity, (b) the geographic location of the entity, and (c) the rank for the entity with data stored in the data processing model steering table, which one of a plurality of versions of a second specific module of the data processing model instructions is applicable to the entity; and
determining, by accessing a second data table associated with the second specific module of the data processing instructions, and based on which one of the plurality of versions of the second specific module of the data processing model instructions is determined to be applicable to the entity, a data processing modifier associated with the entity.

5. The data processing system of claim 4, wherein the data processing model instructions, when executed by the plurality of electronic processing devices, further result in:
determining, based on a fourth comparison of (a) the characteristic of the entity and (b) the geographic location of the entity with data stored in the data processing model steering table, which one of a plurality of versions of a third specific module of the data processing model instructions is applicable to the entity; and
determining, by accessing a third data table associated with the third specific module of the data processing instructions, and based on which one of the plurality of versions of the third specific module of the data processing model instructions is determined to be applicable to the entity, a data processing factor associated with the entity.

6. The data processing system of claim 4, wherein the data processing model instructions, when executed by the plurality of electronic processing devices, further result in:
calculating, in accordance with a stored formula utilizing the data processing modifier, the data processing factor, and the data processing result, a modified data processing result for the entity; and
outputting, by the electronic communications network transceiver device, an indication of the modified data processing result for the entity.

7. The data processing system of claim 6, wherein the modified data processing result for the entity comprises a total insurance premium.

8. The data processing system of claim 1, wherein the data processing result for the entity comprises a base insurance premium.

9. A data processing system, comprising:
a plurality of electronic processing devices;
an electronic communications network transceiver device in communication with the plurality of electronic processing devices; and
a memory device in communication with the plurality of electronic processing devices, the memory device storing (1) data processing model instructions comprising a set of programmatically distinct data processing modules, the modules comprising (i) a first module, (ii) a second module, and (iii) a third module, and each module comprising a plurality of versions, and (2) a data processing model steering table, wherein the data processing model instructions, when executed by the plurality of electronic processing devices, result in:
(i) receiving as input, into the data processing model instructions and from at least one remote data device, and via the electronic communications network transceiver device, data descriptive of (a) a characteristic of an entity and (b) a geographic location of the entity;
(ii) determining, by the data processing model instructions and based on a comparison of (a) the characteristic of the entity and (b) the geographic location of the entity with the data processing model steering table, a first version of the first module that is applicable to the entity;
(iii) determining, by the first version of the first module and based on an accessing of data stored in a first data table associated with the first version of the first module, a data processing rank applicable to the entity;
(iv) determining, by the data processing model instructions and based on a comparison of (a) the characteristic of the entity, (b) the geographic location of the entity, and (c) a data processing rank applicable to the entity with the data processing model steering table, a first version of the second module that is applicable to the entity;
(v) determining, by the first version of the second module and based on an accessing of data stored in a second data table associated with the first version of the second module, a data processing modifier applicable to the entity;
(vi) determining, by the data processing model instructions and based on a comparison of (a) the characteristic of the entity and (b) the geographic location of the entity with the data processing model steering table, a first version of the third module that is applicable to the entity;
(vii) determining, by the first version of the third module and based on an accessing of data stored in a third data table associated with the first version of the third module, a data processing factor applicable to the entity;
(viii) calculating, by the data processing model instructions and based on the data descriptive of (a) the characteristic of the entity and (b) the geographic location of the entity, a base data processing result for the entity;
(ix) modifying, by the data processing model instructions and utilizing the data processing modifier and the data processing factor applicable to the entity, the base data processing result for the entity, thereby defining a modified data processing result for the entity; and
(x) outputting, by the electronic communications network transceiver device, an indication of the modified data processing result for the entity.

10. The data processing system of claim 9, wherein the base data processing result for the entity comprises a base insurance premium.

11. The data processing system of claim 9, wherein the modified data processing result for the entity comprises a total insurance premium.
